(19) United States
(12) Patent Application Publication
(10) Pub. No.: US 2002/0013246 A1
(43) Pub. Date: Jan. 31, 2002

(54) Composition and method for bleaching laundry fabrics

(75) Inventors: Roelant Mathijs Hermant, Vlaardingen (NL); Christiaan Lamers, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 09/796,141

(22) Filed: Feb. 28, 2001

(30) Foreign Application Priority Data
Mar. 1, 2000 (GB) 0005088.0

(51) Int. Cl. C11D 9/42

(52) U.S. Cl. 510/302; 510/311; 510/309; 510/312; 510/313; 510/314

(57) ABSTRACT

A bleaching composition for laundry fabrics is provided, comprising:

hydrogen peroxide or a source of hydrogen peroxide;

a bleach catalyst comprising a ligand which forms a complex with a transition metal, the complex catalyzing bleaching of stains in the presence of peroxygen bleach or a peroxy-based or -generating bleach system; and

less than 4.0% by weight of a peroxyacid bleach precursor.

The bleaching composition provides effective bleaching performance on fabric stains without causing unacceptable dye damage or dye fading of the fabrics after repeated washes.

This invention relates to bleaching compositions and methods based on hydrogen peroxide or a source of hydrogen peroxide with peracid precursors, more particularly to compositions and methods for stain bleaching of laundry fabrics.

Peroxygen bleaches are well known for their ability to remove stains from substrates. Traditionally, the substrate is subjected to hydrogen peroxide, or to substances which can generate hydroperoxyl radicals, such as inorganic or organic peroxides. Generally, these systems must be activated. One method of activation is to employ wash temperatures of 60° C. or higher. However, these high temperatures often lead to inefficient cleaning, and can also cause premature damage to the substrate.

A preferred approach to generating hydroperoxyl bleach radicals is the use of inorganic peroxides coupled with organic precursor compounds. These systems are employed for many commercial laundry powders. For example, various European systems are based on tetraacetyl ethylenediamine (TAED) as the organic precursor coupled with sodium perborate or sodium percarbonate, whereas in the United States laundry bleach products are typically based on sodium nonanoyloxybenzenesulphonate (SNOBS) as the organic precursor coupled with sodium perborate.

Conventional bleaching systems based on hydrogen peroxide, peroxide compounds and/or peroxyacids with peracid precursors such as TAED can provide effective bleaching performance on a variety of stain types on fabrics. However, when present in the amounts necessary to ensure effective bleaching of stains, these bleaching systems can perceptibly damage the dyes used in the fabrics and thus result in unacceptable levels of dye fading after repeated laundry washing of the fabrics.

It would therefore be desirable to be able to provide a bleaching composition and method for stain bleaching of laundry fabrics, which can yield comparable or improved stain bleaching performance on fabrics relative to conventional bleaching systems that employ peracid bleach precursors, whilst at the same time resulting in reduced dye damage and thus more acceptable levels of dye fading after repeated fabric washes.

We have now found that this may be achieved by compositions and methods using a bleach catalyst as defined herein in combination with a relatively limited amount of a peracid bleach precursor, and hydrogen peroxide or a source of hydrogen peroxide, within particular compositional limits as specified herein.

Accordingly, in a first aspect, the present invention provides a bleaching composition for laundry fabrics, comprising:

hydrogen peroxide or a source of hydrogen peroxide;

a bleach catalyst comprising a ligand which forms a complex with a transition metal, the complex catalysing bleaching of stains in the presence of peroxygen bleach or a peroxy-based or -generating bleach system; and

less than 4.0% by weight of a peroxyacid bleach precursor.

In a second aspect, the present invention provides a method of bleaching stains on laundry fabrics comprising contacting the stained fabric with the above bleaching composition.

We have found that the use of certain bleach catalysts, the most preferred of which is FeMeN4Py, in conjunction with a source of hydrogen peroxide, for example sodium percarbonate or sodium perborate, gives much reduced dye fading compared to a conventional precursor/peroxide system such as TAED/percarbonate, whilst delivering equivalent or improved stain bleaching.

These catalysts, and preferably the catalyst FeMeN4Py, used with a peroxide source and low levels of a peracid bleach precursor such as TAED, similarly give reduced dye fading compared to conventional systems that use peracid bleach precursors, whilst delivering equivalent or improved stain bleaching.

According to the present invention, the amount of peracid precursor used in the composition is less than the amount that is used in conventional peroxide/peracid precursor systems. Thus, the amount of peracid precursor in the composition according to the present invention will be less than 4.0% by weight, preferably less than 3.0%, more preferably less than 2.0% by weight, for example from 0.01 to 1.9%, and most preferably from 0.1 to 1.0%, by weight of the composition.

The composition is preferably used in a laundry wash liquor, preferably an aqueous wash liquor. The amount of catalyst in the composition according to the present invention is sufficient to provide a concentration in the wash liquor of generally 0.05 μm to 50 mM, preferably from 0.5 μM to 100 μM, more preferably from 1 μM to 10 μM. The amount of peracid bleach precursor in the composition according to the present invention is sufficient to provide a concentration in the wash liquor of preferably from 0.01 mM to 1 mM, more preferably from 0.05 mM to 0.5 mM.

The molar ratio of peracid bleach precursor to catalyst in the composition is preferably from 1:1 to 1000:1, more preferably from 10:1 to 500:1.

Any suitable peracid precursors may be used in accordance with the present invention. Preferably the composition comprises the peroxyacid bleach precursor tetraacetyl ethylenediamine (TAED). Preferably, TAED is used in the composition in an amount 0.001 to less than 4.0% by weight, more preferably 0.01 to less than 2.0% by weight, and most preferably from 0.1 to 1% by weight, of the composition.

Whilst any suitable substance may incorporated in the composition to generate hydroperoxyl radicals, for example hydrogen peroxide, inorganic or organic peroxides, we prefer that the composition comprises an alkali metal percarbonate, preferably sodium percarbonate, as a source of hydrogen peroxide. Preferably, sodium percarbonate is present in an amount of from 1 to 40% by weight, preferably from 1 to 20% by weight, more preferably from 1 to 15% by weight, and most preferably from 1 to 10% by weight, of the composition.

The bleach catalyst used in the composition comprises a ligand which forms a complex with a transition metal, the complex catalysing bleaching of stains in the presence of peroxygen bleach or a peroxy-based or -generating bleach system. Suitable bleach catalysts are described further below. Preferably, the composition comprises an iron complex comprising the ligand N,N-bis(pyridin-2-yl-methyl)-1,1-bis(pyridin-2-yl)-1-aminoethane (FeMeN4Py), as bleach catalyst.

In a preferred embodiment, the composition comprises sodium percarbonate and TAED, and preferably in a weight ratio of percarbonate to TAED of from 20:1 to 2:1, more preferably from 10:1 to 4:1, and most preferably from 8:1 to 4:1, and the bleach catalyst preferably is FeMeN4Py. The weight ratio of TAED to catalyst preferably is from 100:1 to 2:1, more preferably from 10:1 to 4:1, and most preferably from 8:1 to 4:1.

The catalyst may comprise a preformed complex of a ligand and a transition metal. Alternatively, the catalyst may comprise a free ligand that complexes with a transition metal already present in the water or that complexes with a transition metal present in the substrate. The catalyst may also be included in the form of a composition of a free ligand or a transition metal-substitutable metal-ligand complex, and a source of transition metal, whereby the complex is formed in situ in the medium.

The ligand forms a complex with one or more transition metals, in the latter case for example as a dinuclear complex. Suitable transition metals include for example:

manganese in oxidation states II-V, iron II-V, copper I-III, cobalt I-III, titanium II-IV, tungsten IV-VI, vanadium II-V and molybdenum II-VI.

The ligand forms a complex of the general formula (A1):

[MₐLₖXₙ]Yₘ (A1)

in which:

M represents a metal selected from Mn(II)-(III)-(IV)-V), Cu(I)-(II)-(III), Fe(II)-(III)-(IV)-(V), Co(I)-(II)-(III), Ti (II) -(III) -(IV), V(II)-(III) -(IV) -(V), Mo(II)-(III)-(IV)-(V)-(VI) and W(IV)-(V)-(VI), preferably selected from Fe(II)-(III)-(IV)-(V);

L represents a ligand as herein defined, or its protonated or deprotonated analogue;

X represents a coordinating species selected from any mono, bi or tri charged anions and any neutral molecules able to coordinate the metal in a mono, bi or tridentate manner, preferably selected from O²⁻, RBO₂²⁻, RCOO⁻, RCONR⁻, OH⁻, NO₃⁻, NO, S²⁻, RS⁻, PO₄³⁻, PO₃OR³⁻, H₂O, CO₃²⁻, HCO₃⁻, ROH, N (R)₃, ROO⁻, O₂²⁻, O₂⁻, RCN, Cl⁻, Br⁻, OCN⁻, SCN^{—}, CN⁻, N₃ , F⁻, I⁻, RO⁻, ClO₄⁻, and CF₃SO₃⁻, and more preferably selected from O²⁻, RBO₂²⁻, RCOO⁻, OH⁻, NO₃⁻, S²⁻, RS⁻, PO₃^{4—}, H₂O, CO₃²⁻, HCO₃⁻, ROH, N (R)₃, Cl⁻, Br⁻, OCN⁻, SCN⁻, RCN, N₃⁻, F⁻, I⁻, RO⁻, ClO₄⁻, and CF₃SO₃⁻;

Y represents any non-coordinated counter ion, preferably selected from ClO₄⁻, BR₃⁻, [MX₄]⁻, [MX₄]²⁻, PF₆^{—}, RCOO⁻, NO₃⁻, RO⁻, N⁺(R)₄, ROO⁻, O₂²⁻, O₂⁻, Cl⁻, Br⁻, F⁻, I⁻, CF₃SO₃⁻, S₂O₆²⁻, OCN⁻, SCN⁻, H₂O, RBO₂²⁻, BF₄⁻ and BPh₄⁻, and more preferably selected from ClO₄⁻, BR₄⁻, [FeCl₄]⁻, PF₄⁻, RCOO⁻, NO₃⁻, RO⁻, N⁺(R)₄, Cl⁻, Br⁻, F⁻, I⁻, CF₃SO₃⁻, S₂O₆²⁻, OCN⁻, SCN⁻, H₂O and BF₄⁻;

a represents an integer from 1 to 10, preferably from 1 to 4;

k represents an integer from 1 to 10;

n represents an integer from 1 to 10, preferably from 1 to 4;

m represents zero or an integer from 1 to 20, preferably from 1 to 8; and

each R independently represents a group selected from hydrogen, hydroxyl, —R′ and —OR′, wherein R′=alkyl, alkenyl, cycloalkyl, heterocycloalkyl, aryl, heteroaryl or a carbonyl derivative group, R′ being optionally substituted by one or more functional groups E, wherein E independently represents a functional group selected from —F, —Cl, —Br, —I, —OH, —OR′, —NH₂, —NHR′, —N (R′)₂, —N (R′)₃⁺, —C (O)R′, —OC(O)R′, —COOH, —COO^{—}(Na⁺, K⁺), —COOR′, —C (O) NH₂, —C (O) NHR′, —C (O) N (R′)₂, heteroaryl, —R′, —SR′, —Sh, —P(R′)₂, —P(O) (R′)₂, —P(O) (OH)₂, —P(O) (OR′)₂, —NO₂, —SO₃H, —SO₃⁻(Na⁺, K⁺) , —S (O)₂R′, —NHC (O) R′, and —N (R′) C (O) R′, wherein R′ represents cycloalkyl, aryl, arylalkyl, or alkyl optionally substituted by —F⁻, —Cl, —Br, —I, —NH₃⁺, —SO₃H, —SO₃⁻(Na⁺, K⁺) , —COOH, —COO⁻(Na⁺, K⁺) , —P(O) (OH)₂, or —P (O) (O⁻(Na⁺, K⁺) )₂, and preferably each R independently represents hydrogen, optionally substituted alkyl or optionally substituted aryl, more preferably hydrogen or optionally substituted phenyl, naphthyl or C₁₋₄-alkyl.

Preferably, the complex is an iron complex comprising the ligand N,N-bis(pyridin-2-yl-methyl)-1,1-bis(pyridin-2-yl)-1-aminoethane. However, it will be appreciated that the present invention may instead, or additionally, use other ligands and transition metal complexes, provided that the complex formed is capable of catalysing stain bleaching in the presence of peroxygen bleach or a peroxy-based or -generating bleach system. Suitable classes of ligands are described below:

(A) Ligands of the general formula (IA):

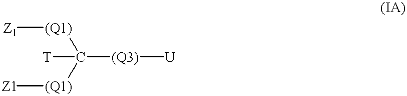

wherein

Z1 groups independently represent a coordinating group selected from hydroxy, amino, —NHR or —N (R)₂ (wherein R=C₁₋₆-alkyl), carboxylate, amido, —NH—C(NH)NH₂, hydroxyphenyl, a heterocyclic ring optionally substituted by one or more functional groups E or a heteroaromatic ring optionally substituted by one or more functional groups E, the heteroaromatic ring being selected from pyridine, pyrimidine, pyrazine, pyrazole, imidazole, benzimidazole, quinoline, quinoxaline, triazole, isoquinoline, carbazole, indole, isoindole, oxazole and thiazole;

Q1 and Q3 independently represent a group of the formula:

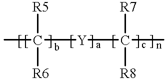

wherein 5≧a+b+c 24 1; a=0-5; b=0-5; c=0-5; n=0 or 1 (preferably n=0);

Y independently represents a group selected from —O—, −S—, —SO—, —SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E;

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I;

T represents a non-coordinated group selected from hydrogen, hydroxyl, halogen, —R and —OR, wherein R represents alkyl, alkenyl, cycloalkyl, heterocycloalkyl, aryl, arylalkyl, heteroaryl or a carbonyl derivative group, R being optionally substituted by one or more functional groups E (preferably T═—H, —OH, methyl, methoxy or benzyl);

U represents either a non-coordinated group T independently defined as above or a coordinating group of the general formula (IIA), (IIIA) or (IVA):

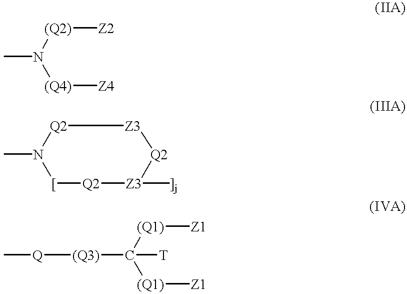

wherein

Q2 and Q4 are independently defined as for Q1 and Q3;

Q represents —N (T)—(wherein T is independently defined as above), or an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole;

Z2 is independently defined as for Z1;

Z3 groups independently represent —N (T)—(wherein T is independently defined as above);

Z4 represents a coordinating or non-coordinating group selected from hydrogen, hydroxyl, halogen, —NH—C(NH)NH₂, R and —OR, wherein R=alkyl, alkenyl, cycloalkyl, heterocycloalkyl, aryl, heteroaryl or a carbonyl derivative group, R being optionally substituted by one or more functional groups E, or Z4 represents a group of the general formula (IIAa):

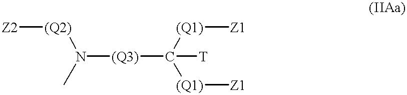

and

1≦j <4.

Preferably, Z1, Z2 and Z4 independently represent an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole. More preferably, Z1, Z2 and Z4 independently represent groups selected from optionally substituted pyridin-2-yl, optionally substituted imidazol-2-yl, optionally substituted imidazol-4-yl, optionally substituted pyrazol-1-yl, and optionally substituted quinolin-2-yl. Most preferred is that Z1 , Z2 and Z4 each represent optionally substituted pyridin-2-yl.

The groups Z1, Z2 and Z4 if substituted, are preferably substituted by a group selected from C₁₋₄-alkyl, aryl, arylalkyl, heteroaryl, methoxy, hydroxy, nitro, amino, carboxyl, halo, and carbonyl. Preferred is that Z1, Z2 and Z4 are each substituted by a methyl group. Also, we prefer that the Z1 groups represent identical groups.

Each Q1 preferably represents a covalent bond or C₁-C₄-alkylene, more preferably a covalent bond, methylene or ethylene, most preferably a covalent bond.

Group Q preferably represents a covalent bond or C₁-C₄-alkylene, more preferably a covalent bond. The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5-R8 is linked together.

Non-coordinated group T preferably represents hydrogen, hydroxy, methyl, ethyl, benzyl, or methoxy.

In one aspect, the group U in formula (IA) represents a coordinating group of the general formula (IIA):

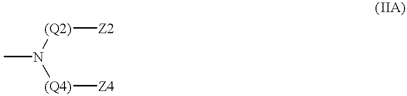

According to this aspect, it is preferred that Z2 represents an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole, more preferably optionally substituted pyridin-2-yl or optionally substituted benzimidazol-2-yl.

It is also preferred, in this aspect, that Z4 represents an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole, more preferably optionally substituted pyridin-2-yl, or an non-coordinating group selected from hydrogen, hydroxy, alkoxy, alkyl, alkenyl, cycloalkyl, aryl, or benzyl.

In preferred embodiments of this aspect, the ligand is selected from:

1,1-bis(pyridin-2-yl)-N-methyl-N-(pyridin-2-ylmethyl)methylamine;

1,1-bis(pyridin-2-yl)-N,N-bis(6-methyl-pyridin-2-ylmethyl)methylamine;

1,1-bis(pyridin-2-yl)-N,N-bis(5-carboxymethyl-pyridin-2-ylmethyl)methylamine;

1,1-bis(pyridin-2-yl)-1-benzyl-N,N-bis(pyridin-2-ylmethyl)methylamine; and

1,1-bis(pyridin-2yl)-N,N-bis(benzimidazol-2-ylmethyl)methylamine.

In a variant of this aspect, the group Z4 in formula (IIA) represents a group of the general formula (IIAa):

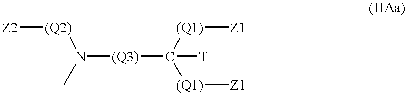

In this variant, Q4 preferably represents optionally substituted alkylene, preferably —CH₂—CHOH—CH₂— or —CH₂—CH₂−CH₂—. In a preferred embodiment of this variant, the ligand is:

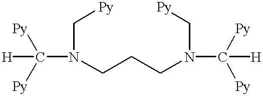

wherein —Py represents pyridin-2-yl.

In another aspect, the group U in formula (IA) represents a coordinating group of the general formula (IIIA):

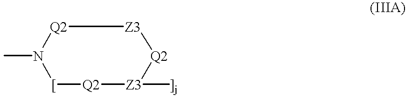

wherein j is 1 or 2, preferably 1.

According to this aspect, each Q2 preferably represents —(CH₂)ₙ—(n=2-4), and each Z3 preferably represents —N (R)—wherein R═—H or C₁₋₄-alkyl, preferably methyl.

In preferred embodiments of this aspect, the ligand is selected from:

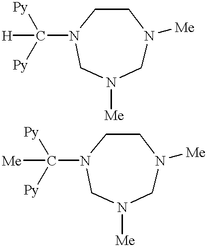

wherein —Py represents pyridin-2-yl.

In yet another aspect, the group U in formula (IA) represents a coordinating group of the general formula (IVA):

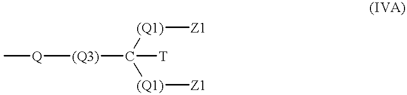

In this aspect, Q preferably represents —N (T)—(wherein T═−H, methyl, or benzyl) or pyridin-diyl.

In preferred embodiments of this aspect, the ligand is selected from:

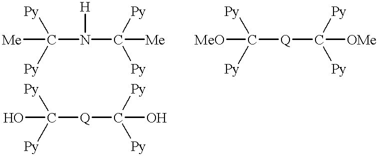

wherein —Py represents pyridin-2-yl, and —Q—represents pyridin-2,6-diyl.

(B) Ligands of the general formula (IB):

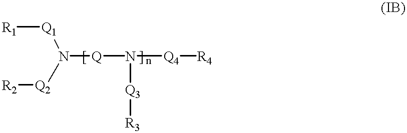

wherein

n=1 or 2, whereby if n=2, then each —Q₃—R₃ group is independently defined;

R₁, R₂, R₃, R₄ independently represent a group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E,

Q₁, Q_{2,} Q_{3,} Q₄ and Q independently represent a group of the formula:

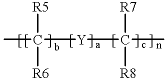

wherein

5≧a+b+c ≧1; a=0-5; b=0-5; c=0-5; n=1 or 2;

Y independently represents a group selected from —O—, —S—, —SO—, —SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E;

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen, or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I,

provided that at least two of R₁, R₂, R₃, R₄ comprise coordinating heteroatoms and no more than six heteroatoms are coordinated to the same transition metal atom.

At least two, and preferably at least three, of R₁, R₂, R₃, R₄ independently represent a group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole.

Preferably, substituents for groups R₁, R₂, R₃, R₄, when representing a heterocyclic or heteroaromatic ring, are selected from C₁₋₄-alkyl, aryl, arylalkyl, heteroaryl, methoxy, hydroxy, nitro, amino, carboxyl, halo, and carbonyl.

The groups Q₁, Q_{2,} Q_{3,} Q₄ preferably independently represent a group selected from —CH₂— and —CH₂CH₂—.

Group Q is preferably a group selected from —(CH₂)₂₋₄—, —CH₂CH (OH) CH₂—,

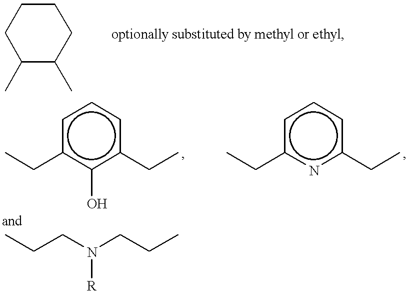

wherein R represents —H or C₁₋₄-alkyl.

Preferably, Q₁, Q_{2,} Q_{3,} Q₄ are defined such that a=b=0, c=1 and n=1, and Q is defined such that a=b=0, c=2 and n=1.

The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5—R8 is linked together.

In a preferred aspect, the ligand is of the general formula (IIB):

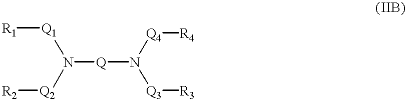

wherein Q₁, Q₂, Q₃, Q₄ are defined such that a=b=0, c=1 or 2 and n=1;

O is defined such that a=b=0, c=2,3 or 4 and n=1; and

R₁, R₂, R₃, R₄, R7, R8 are independently defined as for formula (I).

Preferred classes of ligands according to this aspect, as represented by formula (IIB) above, are as follows:

(i) ligands of the general formula (IIB) wherein:

R₁, R₂, R₃, R₄ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole.

In this class, we prefer that:

Q is defined such that a=b=0, c=2 or 3 and n=1;

R₁, R₂, R₃, R₄ each independently represent a coordinating group selected from optionally substituted pyridin-2-yl, optionally substituted Imidazol-2-yl, optionally substituted imidazol-4-yl, optionally substituted pyrazol-1-yl, and optionally substituted quinolin-2-yl.

(ii) ligands of the general formula (IIB) wherein:

R₁, R₂, R₃ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and

R₄ represents a group selected from hydrogen, C₁₋₂₀ optionally substituted alkyl, C₁₋₂₀ optionally substituted arylalkyl, aryl, and C₁₋₂₀ optionally substituted NR₃⁺ (wherein R=C₁₋₈-alkyl).

In this class, we prefer that:

Q is defined such that a=b=0, c=2 or 3 and n=1;

R₁, R₂, R₃ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

R₄ represents a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

(iii) ligands of the general formula (IIB) wherein:

R₁, R₄ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and

R₂, R₃ each independently represent a group selected from hydrogen, C₁₋₂ optionally substituted alkyl, C₁₋₂₀ optionally substituted arylalkyl, aryl, and C₁₋₂₀ optionally substituted NR₃⁺ (wherein R=C₁₋₈-alkyl).

In this class, we prefer that:

Q is defined such that a=b=0, c=2 or 3 and n=1;

R₁, R₄ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

R₂, R₃ each independently represent a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

Examples of preferred ligands in their simplest forms are:

N,N′, N′-tris(3-methyl-pyridin-2-ylmethyl)-ethylenediamine;

N-trimethylammoniumpropyl-N,N′, N′-tris(pyridin-2-ylmethyl)-ethylenediamine;

N—(2-hydroxyethylene)-N,N′, N′-tris(pyridin-2-ylmethyl)-ethylenediamine;

N,N,N′, N′-tetrakis(3-methyl-pyridin-2-ylmethyl)-ethylene-diamine;

N,N′-dimethyl-N,N′-bis(pyridin-2-ylmethyl)-cyclohexane-1,2-diamine;

N—(2-hydroxyethylene)-N,N′, N′-tris(3-methyl-pyridin-2-ylmethyl)-ethylenediamine;

N-methyl-N,N′, N′-tris(pyridin-2-ylmethyl)-ethylenediamine;

N-methyl-N,N′, N′-tris(5-ethyl-pyridin-2-ylmethyl)-ethylenediamine;

N-methyl-N,N′, N′-tris(5-methyl-pyridin-2-ylmethyl)-ethylenediamine;

N-methyl-N,N′, N′-tris(3-methyl-pyridin-2-ylmethyl)-ethylenediamine;

N-benzyl-N,N′, N′-tris(3-methyl-pyridin-2-ylmethyl)-ethylenediamine;

N-ethyl-N,N′, N′-tris(3-methyl-pyridin-2-ylmethyl)-ethylenediamine;

N,N,N′-tris(3-methyl-pyridin-2-ylmethyl)-N′(2′-methoxy-ethyl-1)-ethylenediamine;

N,N,N′-tris(l-methyl-benzimidazol-2-yl)-N′-methyl-ethylenediamine;

N—(furan-2-yl)-N,N′, N′-tris(3-methyl-pyridin-2-ylmethyl)-ethylenediamine;

N—(2-hydroxyethylene)-N,N′, N′-tris(3-ethyl-pyridin-2-ylmethyl)-ethylenediamine;

N-methyl-N,N′, N′-tris(3-methyl-pyridin-2-ylmethyl)ethylene-1,2-diamine;

N-ethyl-N,N′, N′-tris(3-methyl-pyridin-2-ylmethyl)ethylene-1,2-diamine;

N-benzyl-N,N′, N′-tris(3-methyl-pyridin-2-ylmethyl)ethylene-1,2-diamine;

N—(2-hydroxyethyl)-N,N′, N′-tris(3-methyl-pyridin-2-ylmethyl)ethylene-1,2-diamine;

N—(2-methoxyethyl)-N,N′, N′-tris(3-methyl-pyridin-2-ylmethyl)ethylene-1,2-diamine;

N-methyl-N,N′, N′-tris(5-methyl-pyridin-2-ylmethyl)ethylene-1,2-diamine;

N-ethyl-N,N′, N′-tris(5-methyl-pyridin-2-ylmethyl)ethylene-1,2-diamine;

N-benzyl-N,N′, N′-tris(5-methyl-pyridin-2-ylmethyl)ethylene-1,2-diamine;

N—(2-hydroxyethyl)-N,N′, N′-tris(5-methyl-pyridin-2-ylmethyl)ethylene-1,2-diamine;

N—(2-methoxyethyl)-N,N′, N′-tris(5-methyl-pyridin-2-ylmethyl)ethylene-1,2-diamine;

N-methyl-N,N′, N′-tris(3-ethyl-pyridin-2-ylmethyl)ethylene-1,2-diamine;

N-ethyl-N,N′, N′-tris(3-ethyl-pyridin-2-ylmethyl)ethylene-1,2-diamine;

N-benzyl-N,N′, N′-tris(3-ethyl-pyridin-2-ylmethyl)ethylene-1,2-diamine;

N—(2-hydroxyethyl)-N,N′, N′-tris(3-ethyl-pyridin-2-ylmethyl)ethylene-1,2-diamine;

N—(2-methoxyethyl)-N,N′, N′-tris(3-ethyl-pyridin-2-ylmethyl)ethylene-1,2-diamine;

N-methyl-N,N′, N′-tris(5-ethyl-pyridin-2-ylmethyl)ethylene-1,2-diamine;

N-ethyl-N,N′, N′-tris(5-ethyl-pyridin-2-ylmethyl)ethylene-1,2-diamine;

N-benzyl-N,N′, N′-tris(5-ethyl-pyridin-2-ylmethyl)ethylene-1,2-diamine; and

N—(2-methoxyethyl)-N,N′, N′-tris(5-ethyl-pyridin-2-ylmethyl)ethylene-1,2-diamine.

More preferred ligands are:

N-methyl-N,N′, N′-tris(3-methyl-pyridin-2-ylmethyl)ethylene-1,2-diamine;

N-ethyl-N,N′, N′-tris(3-methyl-pyridin-2-ylmethyl)ethylene-1,2-diamine;

N-benzyl-N,N′, N′-tris(3-methyl-pyridin-2-ylmethyl)ethylene-1,2-diamine;

N—(2-hydroxyethyl)-N,N′, N′-tris(3-methyl-pyridin-2-ylmethyl)ethylene-1,2-diamine; and

N—(2-methoxyethyl)-N,N′, N′-tris(3-methyl-pyridin-2-ylmethyl)ethylene-1,2-diamine.

(C) Ligands of the general formula (IC):

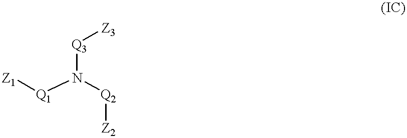

wherein

Z1, Z₂ and Z₃ independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole;

Q₁, Q₂, and Q₃ independently represent a group of the formula:

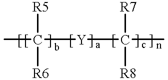

wherein

5≧a+b+c≧1; a=-0-5; b=0-5; c=0-5; n=l or 2;

Y independently represents a group selected from —O—, —S—, —SO—, —SO₂—, —C(O)-, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E; and

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I.

Z₁, Z₂ and Z₃ each represent a coordinating group, preferably selected from optionally substituted pyridin-2-yl, optionally substituted imidazol-2-yl, optionally substituted imidazol-4-yl, optionally substituted pyrazol-1-yl, and optionally substituted quinolin-2-yl. Preferably, Z₁, Z₂ and Z₃ each represent optionally substituted pyridin-2-yl.

Optional substituents for the groups Z1, Z₂ and Z₃ are preferably selected from C₁₋₄-alkyl, aryl, arylalkyl, heteroaryl, methoxy, hydroxy, nitro, amino, carboxyl, halo, and carbonyl, preferably methyl.

Also preferred is that Q₁, Q₂ and Q₃ are defined such that a=b=0, c=l or 2, and n=1.

Preferably, each Q₁, Q₂ and Q₃ independently represent C₁₋₄-alkylene, more preferably a group selected from —CH₂— and —CH₂CH₂—.

The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, CO-C₂₀-alkyl, alkoxy-C₀-C₈-alkyl, carbonyl-C₀-C₆-alkoxy, and C₀-C20-alkylamide. Preferably, none of R5—R8 is linked together.

Preferably, the ligand is selected from tris(pyridin-2-ylmethyl)amine, tris(3-methyl-pyridin-2-ylmethyl)amine, tris(5-methyl-pyridin-2-ylmethyl)amine, and tris(6-methyl-pyridin-2-ylmethyl)amine.

(D) Ligands of the general formula (ID):

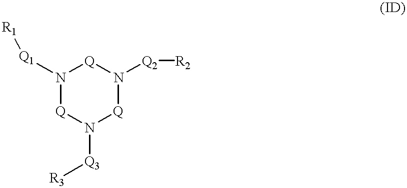

wherein

R₁, R₂, and R₃ independently represent a group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E;

Q independently represent a group selected from C₂₋₃-alkylene optionally substituted by H, benzyl or C₁₋₈-alkyl;

Q₁, Q₂ and Q₃ independently represent a group of the formula:

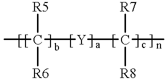

wherein

5≧a+b+c≧1; a=0-5; b=0-5; c=0-5; n=l or 2;

Y independently represents a group selected from —O—, —S—, —SO—, —SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E; and

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I,

provided that at least one, preferably at least two, of R₁, R₂ and R₃ is a coordinating group.

At least two, and preferably at least three, of R₁, R₂ and R₃ independently represent a group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole. Preferably, at least two of R₁, R₂, R₃ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl.

Preferably, substituents for groups R₁, R₂, R₃, when representing a heterocyclic or heteroaromatic ring, are selected from C₁₋₄-alkyl, aryl, arylalkyl, heteroaryl, methoxy, hydroxy, nitro, amino, carboxyl, halo, and carbonyl.

Preferably, Q₁, Q₂ and Q₃ are defined such that a=b=0, c=1,2,3 or 4 and n=1. Preferably, the groups Q₁, Q₂ and Q₃ independently represent a group selected from —CH₂— and -CH₂CH₂—.

Group Q is preferably a group selected from —CH₂CH₂— and −CH₂CH₂CH₂—.

The groups R5, R6, R7, R8 preferably independently represent a group selected from —H, hydroxy-C₀-C₂₀-alkyl, halo-C₀-C20-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5—R8 is linked together.

In a preferred aspect, the ligand is of the general formula (IID):

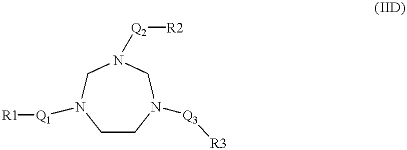

wherein R1, R2, R3 are as defined previously for R₁, R₂, R₃, and Q₁, Q₂, Q₃ are as defined previously.

Preferred classes of ligands according to this preferred aspect, as represented by formula (IID) above, are as follows:

(i) ligands of the general formula (IID) wherein:

R1, R2, R3 each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole.

In this class, we prefer that:

R1, R2, R3 each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl.

(ii) ligands of the general formula (IID) wherein:

two of R1, R2, R3 each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and

one of R1, R2, R3 represents a group selected from hydrogen, C₁₋₂₀ optionally substituted alkyl, C₁₋₂₀ optionally substituted arylalkyl, aryl, and C₁₋₂₀ optionally substituted NR₃⁺ (wherein R=C₁₋₈-alkyl).

In this class, we prefer that:

two of R1, R2, R3 each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

one of R1, R2, R3 represents a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

In especially preferred embodiments, the ligand is selected from:

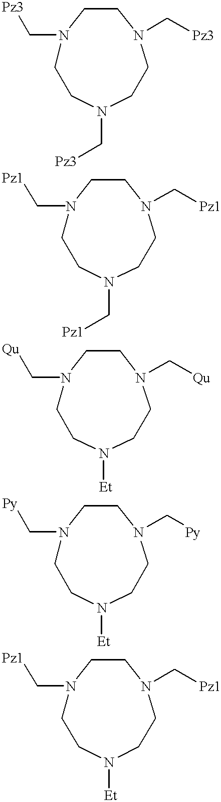

wherein —Et represents ethyl, —Py represents pyridin-2-yl, Pz3represents pyrazol-3-yl, Pz1 represents pyrazol-1-yl, and Qu represents quinolin-2-yl.

(E) Ligands of the general formula (IE):

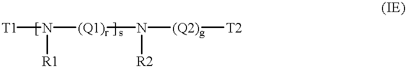

wherein

g represents zero or an integer from 1 to 6;

r represents an integer from 1 to 6;

s represents zero or an integer from 1 to 6;

Q₁ and Q₂ independently represent a group of the formula:

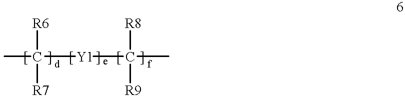

wherein

5≧d+e+f≧1; d=0-5; e=0-5; f=0-5;

each Yl independently represents a group selected from —O—, —S—, —SO—, —SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E;

if s>l, each —[—N (R1)—(Q1)ᵣ—]— group is independently defined;

R1, R2, R6, R7, R8, R9 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R6 together with R7, or R8 together with R9, or both, represent oxygen,

or R6 together with R8 and/or independently R7 together with R9, or R6 together with R9 and/or independently R7 together with R8, represent C₁₋₆-alkylene optionally substituted by C₁₋₄-alkyl, —F, —Cl, —Br or —I;

or one of R1-R9 is a bridging group bound to another moiety of the same general formula;

T1 and T2 independently represent groups R4 and R5, wherein R4 and R5 are as defined for R1-R9, and if g=0 and s>0, R1 together with R4, and/or R2 together with R5, may optionally independently represent ═CH-R10, wherein R10 is as defined for R1-R9, or

T1 and T2 may together (—T2—T1—) represent a covalent bond linkage when s>1 and g>0;

if T1 and T2 together represent a single bond linkage, Q₁ and/or Q₂ may independently represent a group of the formula: ═CH—[—Y1—]e—CH═ provided R1 and/or R2 are absent, and R1 and/or R2 may be absent provided Q₁ and/or Q₂ independently represent a group of the formula: ═CH—[Y1—]e—CH═.

The groups R1-R9 are preferably independently selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulpho-C₀-C₂₀-alkyl and esters and salts thereof, sulphamoyl-C₀-C₂₀-alkyl, amino-C₀-C₂₀-alkyl, aryl-C₀-C₂₀-alkyl, heteroaryl-C₀-C₂₀-alkyl, C₀-C₂₀-alkyl, alkoxy-C₀-C₈-alkyl, carbonyl-C₀-C₆-alkoxy, and aryl-C₀-C₆-alkyl and C₀-C₂₀-alkylamide.

One of R1-R9 may be a bridging group which links the ligand moiety to a second ligand moiety of preferably the same general structure. In this case the bridging group is independently defined according to the formula for Q₁, Q₂, preferably being alkylene or hydroxy-alkylene or a heteroaryl-containing bridge, more preferably C₁₋₆-alkylene optionally substituted by C₁₋₄-alkyl, —F, —Cl, —Br or —I.

In a first variant according to formula (IE), the groups T1 and T2 together form a single bond linkage and s>1, according to general formula (IIE):

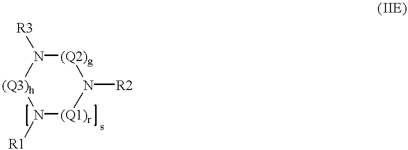

wherein R3 independently represents a group as defined for R1-R9; Q3 independently represents a group as defined for Q1, Q2; h represents zero or an integer from 1 to 6; and s=s-1.

In a first embodiment of the first variant, in general formula (IIE), s=1, 2 or 3; r=g=h=1; d=2 or 3; e=f=0; R6=R7=H, preferably such that the ligand has a general formula selected from:

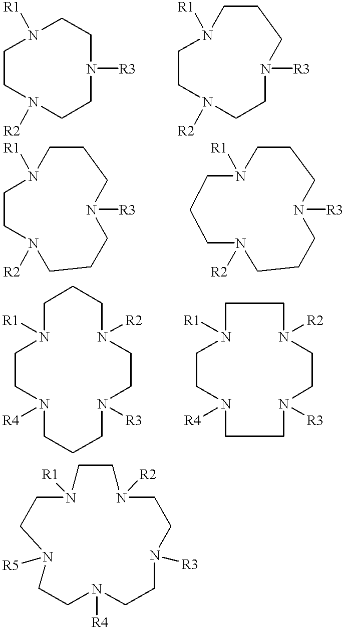

In these preferred examples, R1, R2, R3 and R4 are preferably independently selected from —H, alkyl, aryl, heteroaryl, and/or one of R1-R4 represents a bridging group bound to another moiety of the same general formula and/or two or more of R1-R4 together represent a bridging group linking N atoms in the same moiety, with the bridging group being alkylene or hydroxy-alkylene or a heteroaryl-containing bridge, preferably heteroarylene. More preferably, R1, R2, R3 and R4 are independently selected from —H, methyl, ethyl, isopropyl, nitrogen-containing heteroaryl, or a bridging group bound to another moiety of the same general formula or linking N atoms in the same moiety with the bridging group being alkylene or hydroxy-alkylene.

In a second embodiment of the first variant, in general formula (IIE), s=2 and r=g=h=l, according to the general formula:

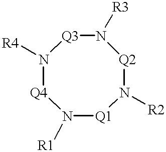

In this second embodiment, preferably R1-R4 are absent; both Q₁ and Q₃ represent ═CH—[—Y1—]e—CH═; and both Q2 and Q4 represent —CH₂[—Y1—]ₙ—CH₂—.

Thus, preferably the ligand has the general formula:

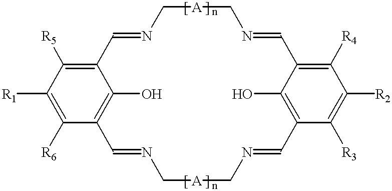

wherein A represents optionally substituted alkylene optionally interrupted by a heteroatom; and n is zero or an integer from 1 to 5.

Preferably, R1 —R6 represent hydrogen, n=1 and A=—CH₂—, —CHOH⁻, —CH₂N (R)CH₂— or —CH₂CH₂N (R)CH₂CH₂— wherein R represents hydrogen or alkyl, more preferably A=—CH₂—, —CHOH— or —CH₂CH₂NHCH₂CH₂—.

In a second variant according to formula (IE), T1 and T2 independently represent groups R4, R5 as defined for R1-R9, according to the general formula (IIIE):

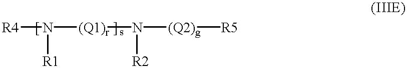

In a first embodiment of the second variant, in general formula (IIIE), s=1; r=1; g=0; d=f=1; e=0-4; Y1=—CH₂—; and R1 together with R4, and/or R2 together with R5, independently represent ═CH—R10, wherein R10 is as defined for R1-R9. In one example, R2 together with R5 represents ═CH—R10, with R1 and R4 being two separate groups. Alternatively, both R1 together with R4, and R2 together with R5 may independently represent ═CH—R10. Thus, preferred ligands may for example have a structure selected from:

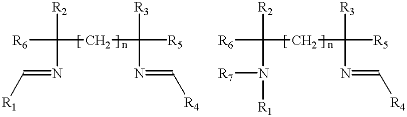

wherein n=0-4.

Preferably, the ligand is selected from:

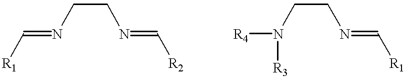

wherein R1 and R2 are selected from optionally substituted phenols, heteroaryl-C₀-C₂₀-alkyls, R3 and R4 are selected from —H, alkyl, aryl, optionally substituted phenols, heteroaryl-C₀-C₂₀-alkyls, alkylaryl, aminoalkyl, alkoxy, more preferably R1 and R2 being selected from optionally substituted phenols, heteroaryl-C₀-C₂-alkyls, R3 and R4 are selected from —H, alkyl, aryl, optionally substituted phenols, nitrogen-heteroaryl-C₀-C₂-alkyls.

In a second embodiment of the second variant, in general formula (IIIE), s=1; r=1; g=0; d=f=1; e=1-4; Yl=—C(R′) (R″), wherein R′ and R″ are independently as defined for R1-R9. Preferably, the ligand has the general formula:

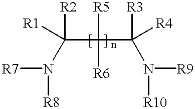

The groups R1, R2, R3, R4, R5 in this formula are preferably —H or C₀-C₂₀-alkyl, n=0 or 1, R6 is —H, alkyl, —OH or —Sh, and R7, R8, R9, R10 are preferably each independently selected from —H, C₀-C₂₀-alkyl, heteroaryl-C₀-C₂₀-alkyl, alkoxy-C₀-C8-alkyl and amino-C₀-C₂₀-alkyl.

In a third embodiment of the second variant, in general formula (IIIE), s=0; g=1; d=e=0; f=1-4. Preferably, the ligand has the general formula:

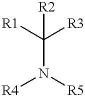

This class of ligand is particularly preferred according to the invention.

More preferably, the ligand has the general formula:

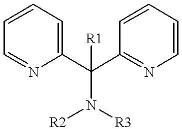

wherein R1, R2, R3 are as defined for R2, R4, R5.

In a fourth embodiment of the second variant, the ligand is a pentadentate ligand of the general formula (IVE):

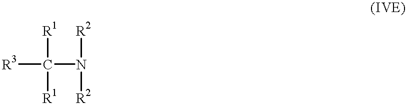

wherein

each R¹, R² independently represents —R⁴—R⁵,

R³ represents hydrogen, optionally substituted alkyl, aryl or arylalkyl, or —R⁴-R⁵,

each R⁴ independently represents a single bond or optionally substituted alkylene, alkenylene, oxyalkylene, aminoalkylene, alkylene ether, carboxylic ester or carboxylic amide, and

each R⁵ independently represents an optionally N-substituted aminoalkyl group or an optionally substituted heteroaryl group selected from pyridinyl, pyrazinyl, pyrazolyl, pyrrolyl, imidazolyl, benzimidazolyl, pyrimidinyl, triazolyl and thiazolyl.

Ligands of the class represented by general formula (IVE) are also particularly preferred according to the invention. The ligand having the general formula (IVE), as defined above, is a pentadentate ligand. By ‘pentadentate’ herein is meant that five hetero atoms can coordinate to the metal M ion in the metal-complex.

In formula (IVE), one coordinating hetero atom is provided by the nitrogen atom in the methylamine backbone, and preferably one coordinating hetero atom is contained in each of the four R¹ and R² side groups. Preferably, all the coordinating hetero atoms are nitrogen atoms.

The ligand of formula (IVE) preferably comprises at least two substituted or unsubstituted heteroaryl groups in the four side groups. The heteroaryl group is preferably a pyridin-2-yl group and, if substituted, preferably a methyl- or ethyl-substituted pyridin-2-yl group. More preferably, the heteroaryl group is an unsubstituted pyridin-2-yl group.

Preferably, the heteroaryl group is linked to methylamine, and preferably to the N atom thereof, via a methylene group. Preferably, the ligand of formula (IVE) contains at least one optionally substituted amino-alkyl side group, more preferably two amino-ethyl side groups, in particular 2-(N-alkyl)amino-ethyl or 2—(N,N-dialkyl)amino-ethyl.

Thus, in formula (IVE) preferably R¹ represents pyridin-2-yl or R² represents pyridin-2-yl-methyl. Preferably R² or R¹ represents 2-amino-ethyl, 2—(N—(m)ethyl)amino-ethyl or 2-(N,N-di(m)ethyl)amino-ethyl. If substituted, R⁵ preferably represents 3-methyl pyridin-2-yl. R³ preferably represents hydrogen, benzyl or methyl.

Examples of preferred ligands of formula (IVE) in their simplest forms are:

(i) pyridin-2-yl containing ligands such as:

N,N-bis (pyridin-2-yl-methyl)-bis(pyridin-2-yl)methylamine;

N,N-bis(pyrazol-1-yl-methyl)-bis(pyridin-2-yl)methylamine;

N,N-bis(imidazol-2-yl-methyl)-bis(pyridin-2-yl)methylamine;

N,N-bis(1,2,4-triazol-1-yl-methyl)-bis(pyridin-2-yl)methylamine;

N,N-bis(pyridin-2-yl-methyl)-bis(pyrazol-1-yl)methylamine;

N,N-bis(pyridin-2-yl-methyl)-bis(imidazol-2-yl)methylamine;

N,N-bis(pyridin-2-yl-methyl)-bis(1,2,4-triazol-1-yl)methylamine;

N,N-bis(pyridin-2-yl-methyl)-1,1-bis(pyridin-2-yl)-1-aminoethane;

N,N-bis(pyridin-2-yl-methyl)-1,1-bis(pyridin-2-yl)-2-phenyl-1-aminoethane;

N,N-bis(pyrazol-1-yl-methyl)-1,1-bis(pyridin-2-yl)-1-aminoethane;

N,N-bis(pyrazol-1-yl-methyl)-1,1-bis(pyridin-2-yl)-2-phenyl-1-aminoethane;

N,N-bis(imidazol-2-yl-methyl)-1,1-bis(pyridin-2-yl)-1-aminoethane;

N,N-bis(imidazol-2-yl-methyl)-1,1-bis(pyridin-2-yl)-2-phenyl-1-aminoethane;

N,N-bis(1,2,4-triazol-1-yl-methyl)-1,1-bis(pyridin-2-yl)-1-aminoethane;

N,N-bis(1,2,4-triazol-1-yl-methyl)-1,1-bis(pyridin-2-yl)-2-phenyl-1-aminoethane;

N,N-bis(pyridin-2-yl-methyl)-1,1-bis(pyrazol-1-yl)-1-aminoethane;

N,N-bis(pyridin-2-yl-methyl)-1,1-bis(pyrazol-1-yl)-2-phenyl-1-aminoethane;

N,N-bis(pyridin-2-yl-methyl)-1,1-bis(imidazol-2-yl)-1-aminoethane;

N,N-bis(pyridin-2-yl-methyl)-1,1-bis(imidazol-2-yl)-2-phenyl-1-aminoethane;

N,N-bis(pyridin-2-yl-methyl)-1,1-bis(1,2,4-triazol-1-yl)-1-aminoethane;

N,N-bis(pyridin-2-yl-methyl)-1,1-bis(1,2,4-triazol-1-yl)-1-aminoethane;

N,N-bis(pyridin-2-yl-methyl)-1,1-bis(pyridin-2-yl)-1-aminoethane;

N,N-bis(pyridin-2-yl-methyl)-1,1-bis(pyridin-2-yl)-1-aminohexane;

N,N-bis(pyridin-2-yl-methyl)-1,1-bis(pyridin-2-yl)-2-phenyl-1-aminoethane;

N,N-bis(pyridin-2-yl-methyl)-1,1-bis(pyridin-2-yl)-2—(4-sulphonic acid-phenyl)-1-aminoethane;

N,N-bis(pyridin-2-yl-methyl)-1,1-bis(pyridin-2-yl)-2-(pyridin-2-yl)-1-aminoethane;

N,N-bis(pyridin-2-yl-methyl)-1,1-bis(pyridin-2-yl)-2-(pyridin-3-yl)-1-aminoethane;

N,N-bis(pyridin-2-yl-methyl)-1,1-bis(pyridin-2-yl)-2-(pyridin-4-yl)-1-aminoethane;

N,N-bis(pyridin-2-yl-methyl)-1,1-bis(pyridin-2-yl)-2—(1-alkyl-pyridinium-4-yl)-1-aminoethane;

N,N-bis(pyridin-2-yl-methyl)-1,1-bis(pyridin-2-yl)-2—(1-alkyl-pyridinium-3-yl)-1-aminoethane;

N,N-bis(pyridin-2-yl-methyl)-1,1-bis(pyridin-2-yl)-2—(1-alkyl-pyridinium-2-yl)-1-aminoethane;

(ii) 2-amino-ethyl containing ligands such as:

N,N-bis(2-(N-alkyl)amino-ethyl)-bis(pyridin-2-yl)methylamine;

N,N-bis(2-(N-alkyl)amino-ethyl)-bis(pyrazol-1-yl)methylamine;

N,N-bis(2-(N-alkyl)amino-ethyl)-bis(imidazol-2-yl)methylamine;

N,N-bis(2-(N-alkyl)amino-ethyl)-bis(1,2,4-triazol-1-yl)methylamine;

N,N-bis(2-(N,N-dialkyl)amino-ethyl)-bis(pyridin-2-yl)methylamine;

N,N-bis(2-(N,N-dialkyl)amino-ethyl)-bis(pyrazol-1-yl)methylamine;

N,N-bis(2-(N,N-dialkyl)amino-ethyl)-bis(imidazol-2-yl)methylamine;

N,N-bis(2-(N,N-dialkyl)amino-ethyl)-bis(1,2,4-triazol-1-yl)methylamine;

N,N-bis(pyridin-2-yl-methyl)-bis(2-amino-ethyl)methylamine;

N,N-bis(pyrazol-1-yl-methyl)-bis(2-amino-ethyl)methylamine;

N,N-bis(imidazol-2-yl-methyl)-bis(2-amino-ethyl)methylamine;

N,N-bis(1,2,4-triazol-1-yl-methyl)-bis(2-amino-ethyl)methylamine.

More preferred ligands are:

N,N-bis(pyridin-2-yl-methyl)-bis(pyridin-2-yl)methylamine, hereafter referred to as N4Py.

N,N-bis(pyridin-2-yl-methyl)-1,1-bis(pyridin-2-yl)-1-aminoethane, hereafter referred to as MeN4Py,

N,N-bis(pyridin-2-yl-methyl)-1,1-bis(pyridin-2-yl)-2-phenyl-1-aminoethane, hereafter referred to as BzN4Py.

In a fifth embodiment of the second variant, the ligand represents a pentadentate or hexadentate ligand of general formula (VE):

R¹R¹N—W—NR¹R² (VE)

wherein

each R¹ independently represents —R³—V, in which R³ represents optionally substituted alkylene, alkenylene, oxyalkylene, aminoalkylene or alkylene ether, and V represents an optionally substituted heteroaryl group selected from pyridinyl, pyrazinyl, pyrazolyl, pyrrolyl, imidazolyl, benzimidazolyl, pyrimidinyl, triazolyl and thiazolyl;

W represents an optionally substituted alkylene bridging group selected from —CH₂CH₂—, —CH₂CH₂CH₂—, —CH₂CH₂CH₂CH₂—, —CH₂—C₆H₄—CH₂CH₂—, and —CH₂-CloH₆—CH₂—; and

R² represents a group selected from R¹, and alkyl, aryl and arylalkyl groups optionally substituted with a substituent selected from hydroxy, alkoxy, phenoxy, carboxylate, carboxamide, carboxylic ester, sulphonate, amine, alkylamine and N⁺(R⁴)₃, wherein R⁴ is selected from hydrogen, alkanyl, alkenyl, arylalkanyl, arylalkenyl, oxyalkanyl, oxyalkenyl, aminoalkanyl, aminoalkenyl, alkanyl ether and alkenyl ether.

The ligand having the general formula (VE), as defined above, is a pentadentate ligand or, if R¹=R², can be a hexadentate ligand. As mentioned above, by ‘pentadentate’ is meant that five hetero atoms can coordinate to the metal M ion in the metal-complex. Similarly, by ‘hexadentate’ is meant that six hetero atoms can in principle coordinate to the metal M ion. However, in this case it is believed that one of the arms will not be bound in the complex, so that the hexadentate ligand will be penta coordinating.

In the formula (VE), two hetero atoms are linked by the bridging group W and one coordinating hetero atom is contained in each of the three R¹ groups. Preferably, the coordinating hetero atoms are nitrogen atoms.

The ligand of formula (VE) comprises at least one optionally substituted heteroaryl group in each of the three R¹ groups. Preferably, the heteroaryl group is a pyridin-2-yl group, in particular a methyl- or ethyl-substituted pyridin-2-yl group. The heteroaryl group is linked to an N atom in formula (VE), preferably via an alkylene group, more preferably a methylene group. Most preferably, the heteroaryl group is a 3-methyl-pyridin-2-yl group linked to an N atom via methylene.

The group R² in formula (VE) is a substituted or unsubstituted alkyl, aryl or arylalkyl group, or a group R¹. However, preferably R² is different from each of the groups R¹ in the formula above. Preferably, R² is methyl, ethyl, benzyl, 2-hydroxyethyl or 2-methoxyethyl. More preferably, R² is methyl or ethyl.

The bridging group W may be a substituted or unsubstituted alkylene group selected from —CH₂CH₂—, —CH₂CH₂CH₂—, —CH₂CH₂CH—₂CH₂—, —CH₂C₆H₄—CH₂—, —CH₂—C₆H₁₀—CH₂—, and —CH₂—C₁₀H₆—CH₂—(wherein —C₆H₄—, —C₆H₁₀—, —C₁₀H₆— can be ortho-, para-, or meta-C₆H₄—, —C₆H₁₀—, —C₁₀H₆—). Preferably, the bridging group W is an ethylene or 1,4-butylene group, more preferably an ethylene group.

Preferably, V represents substituted pyridin-2-yl, especially methyl-substituted or ethyl-substituted pyridin-2-yl, and most preferably V represents 3-methyl pyridin-2-yl.

(F) Ligands of the classes disclosed in WO-A-98/39098 and WO-A-98/39406.

The counter ions Y in formula (A1) balance the charge z on the complex formed by the ligand L, metal M and coordinating species X. Thus, if the charge z is positive, Y may be an anion such as RCOO⁻, BPh₄⁻, ClO₄⁻, BF₄⁻, PF₆⁻, RSO₃⁻, RSO₄⁻, SO₄²⁻, NO₃⁻, F⁻, Cl⁻, Br⁻, or I⁻, with R being hydrogen, optionally substituted alkyl or optionally substituted aryl. If z is negative, Y may be a common cation such as an alkali metal, alkaline earth metal or (alkyl)ammonium cation.

Suitable counter ions Y include those which give rise to the formation of storage-stable solids. Preferred counter ions for the preferred metal complexes are selected from R^{′7}COO—, ClO₄⁻, BF₄⁻, PF₆⁻, RSO₃⁻ (in particular CF₃SO₃⁻) , RSO₄²⁻, SO₄²⁻, NO₃⁻, F⁻, Cl⁻, Br⁻, and I⁻, wherein R represents hydrogen or optionally substituted phenyl, naphthyl or C₁-C₄ alkyl.

It will be appreciated that the complex (A1) can be formed by any appropriate means, including in situ formation whereby precursors of the complex are transformed into the active complex of general formula (A1) under conditions of storage or use. Preferably, the complex is formed as a well-defined complex or in a solvent mixture comprising a salt of the metal M and the ligand L or ligand L-generating species. Alternatively, the catalyst may be formed in situ from suitable precursors for the complex, for example in a solution or dispersion containing the precursor materials. In one such example, the active catalyst may be formed in situ in a mixture comprising a salt of the metal M and the ligand L, or a ligand L-generating species, in a suitable solvent. Thus, for example, if M is iron, an iron salt such as FeSO₄ can be mixed in solution with the ligand L, or a ligand L-generating species, to form the active complex. Thus, for example, the composition may formed from a mixture of the ligand L and a metal salt MXn in which preferably n=1-5, more preferably 1-3. In another such example, the ligand L, or a ligand L-generating species, can be mixed with metal M ions present in the substrate or wash liquor to form the active catalyst in situ. Suitable ligand L-generating species include metal-free compounds or metal coordination complexes that comprise the ligand L and can be substituted by metal M ions to form the active complex according the formula (A1).

In typical washing compositions the level of the catalyst is such that the in-use level is from 0.05 μM to 50 μM, with preferred in-use levels for domestic laundry operations falling in the range 0.5 μM to 100 μM, more preferably from 1 μM to 10 μM.

Preferably, the composition provides a pH in the range from pH 6 to 13, more preferably from pH 6 to 11, still more preferably from pH 8 to 11, and most preferably from pH 8 to 10, in particular from pH 9 to 10.

In the context of the present invention bleaching should be understood as relating generally to the decolorisation of stains or of other materials attached to or associated with a substrate. However, it is envisaged that the present invention can be applied where a requirement is the removal and/or neutralisation by an oxidative bleaching reaction of malodours or other undesirable components attached to or otherwise associated with a substrate. Furthermore, in the context of the present invention bleaching is to be understood as being restricted to any bleaching mechanism or process that does not require the presence of light or activation by light. Thus, photobleaching compositions and processes relying on the use of photobleach catalysts or photobleach activators and the presence of light are excluded from the present invention.

According to the present invention, the composition contains a peroxygen bleach or a peroxy-based or -generating system. The peroxy bleach may be a compound which is capable of yielding hydrogen peroxide in aqueous solution. Hydrogen peroxide sources are well known in the art. They include the alkali metal peroxides, organic peroxides such as urea peroxide, and inorganic persalts, such as the alkali metal perborates, percarbonates, perphosphates persilicates and persulphates. Mixtures of two or more such compounds may also be suitable.

Particularly preferred are sodium perborate tetrahydrate and, especially, sodium perborate monohydrate. Sodium perborate monohydrate is preferred because of its high active oxygen content. Sodium percarbonate may also be preferred for environmental reasons.

Another suitable hydrogen peroxide generating system is a combination of a C₁-C₄ alkanol oxidase and a C₁-C₄ alkanol, especially a combination of methanol oxidase (MOX) and ethanol. Such combinations are disclosed in WO-A-9507972, which is incorporated herein by reference.

Alkylhydroxy peroxides are another class of peroxy bleaching compounds. Examples of these materials include cumene hydroperoxide and t-butyl hydroperoxide.

Organic peroxyacids may also be suitable as the peroxy bleaching compound. Such materials normally have the general formula:

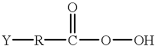

wherein R is an alkyl- or alkylidene- or substituted alkylene group containing from 1 to about 20 carbon atoms, optionally having an internal amide linkage; or a phenylene or substituted phenylene group; and Y is hydrogen, halogen, alkyl, aryl, an imido-aromatic or non-aromatic group, a —COOH or —COOOH group or a quaternary ammonium group.

Typical monoperoxy acids useful herein include, for example:

(i) peroxybenzoic acid and ring-substituted peroxybenzoic acids, e.g. peroxy-a-naphthoic acid;

(ii) aliphatic, substituted aliphatic and arylalkyl monoperoxyacids, e.g. peroxylauric acid, peroxystearic acid and N,N-phthaloylaminoperoxy caproic acid (PAP); and

(iii)6-octylamino-6-oxo-peroxyhexanoic acid.

Typical diperoxyacids useful herein include, for example:

(iv) 1,12-diperoxydodecanedioic acid (DPDA);

(v) 1,9-diperoxyazelaic acid;

(vi) diperoxybrassylic acid; diperoxysebacic acid and diperoxyisophthalic acid;

(vii) 2-decyldiperoxybutane-1,4-dioic acid; and (viii) 4,4′-sulphonylbisperoxybenzoic acid.

Also inorganic peroxyacid compounds are suitable, such as for example potassium monopersulphate (MPS). If organic or inorganic peroxyacids are used as the peroxygen compound, the amount thereof will normally be within the range of about 2-10% by weight, preferably from 4-8% by weight.

Generally, the composition can be suitably formulated to contain from 1 to 40%, preferably from 1 to 20%, more preferably from 1 to 15%, and most preferably from 1 to 10 % by weight of the composition, of the peroxy bleaching agent.

Peroxyacid bleach precursors are known and amply described in literature, such as in GB-A-836988; GB-A-864,798; GB-A-907,356; GB-A-1,003,310 and GB-A-1,519,351; DE-A-3,337,921; EP-A-0,185,522; EP-A-0,174,132; EP-A-0,120,591; and U.S. Pat. Nos. 1,246,339; 3,332,882; 4,128,494; 4,412,934 and 4,675,393.

Another useful class of peroxyacid bleach precursors is that of the cationic i.e. quaternary ammonium substituted peroxyacid precursors as disclosed in U.S. Pat. Nos. 4,751,015 and 4,397,757, in EP-A-0,284,292 and EP-A-331,229. Examples of peroxyacid bleach precursors of this class are: 2-(N,N,N-trimethyl ammonium) ethyl sodium-4-sulphophenyl carbonate chloride—(SPCC);

N-octyl,N,N-dimethyl-N₁₀-carbophenoxy decyl ammonium chloride—(ODC); 3-(N,N,N-trimethyl ammonium) propyl sodium-4-sulphophenyl carboxylate; and

N,N,N-trimethyl ammonium toluyloxy benzene sulphonate.

A further special class of bleach precursors is formed by the cationic nitrites as disclosed in EP-A-303,520; EP-A-458,396 and EP-A-464,880.

Of the above classes of bleach precursors, the preferred classes are the esters, including acyl phenol sulphonates and acyl alkyl phenol sulphonates; the acyl-amides; and the quaternary ammonium substituted peroxyacid precursors including the cationic nitrites.

Examples of said preferred peroxyacid bleach precursors or activators are sodium-4-benzoyloxy benzene sulphonate (SBOBS); N,N,N′N′-tetraacetyl ethylene diamine (TAED); sodium-1-methyl-2-benzoyloxy benzene-4-sulphonate; sodium-4-methyl-3-benzoloxy benzoate; 2-(N,N,N-trimethyl ammonium) ethyl sodium-4-sulphophenyl carbonate chloride (SPCC); trimethyl ammonium toluyloxy-benzene sulphonate; sodium nonanoyloxybenzene sulphonate (SNOBS); sodium 3,5,5-trimethyl hexanoyl-oxybenzene sulphonate (STHOBS); and the substituted cationic nitrites. The peracid precursor TAED is particularly preferred.

The present invention has particular application in detergent bleaching, especially for laundry cleaning. Accordingly, the composition preferably contains a surface-active material, optionally together with detergency builder.

The composition may contain a surface-active material in an amount, for example, of from 10 to 50% by weight.

The surface-active material may be naturally derived, such as soap, or a synthetic material selected from anionic, nonionic, amphoteric, zwitterionic, cationic actives and mixtures thereof. Many suitable actives are commercially available and are fully described in the literature, for example in “Surface Active Agents and Detergents”, Volumes I and II, by Schwartz, Perry and Berch.

Typical synthetic anionic surface-actives are usually water-soluble alkali metal salts of organic sulphates and sulphonates having alkyl groups containing from about 8 to about 22 carbon atoms, the term “alkyl” being used to include the alkyl portion of higher aryl groups. Examples of suitable synthetic anionic detergent compounds are sodium and ammonium alkyl sulphates, especially those obtained by sulphating higher (C8-C18) alcohols produced, for example, from tallow or coconut oil; sodium and ammonium alkyl (C₉-C₂₀) benzene sulphonates, particularly sodium linear secondary alkyl (C₁₀ -C₁₅) benzene sulphonates; sodium alkyl glyceryl ether sulphates, especially those ethers of the higher alcohols derived from tallow or coconut oil fatty acid monoglyceride sulphates and sulphonates; sodium and ammonium salts of sulphuric acid esters of higher (C₉-C₁₈) fatty alcohol alkylene oxide, particularly ethylene oxide, reaction products; the reaction products of fatty acids such as coconut fatty acids esterified with isethionic acid and neutralised with sodium hydroxide; sodium and ammonium salts of fatty acid amides of methyl taurine; alkane monosulphonates such as those derived by reacting alpha-olefins (C₈-C₂₀) with sodium bisulphite and those derived by reacting paraffins with SO₂ and Cl₂ and then hydrolysing with a base to produce a random sulphonate; sodium and ammonium (C₇-C₁₂) dialkyl sulphosuccinates; and olefin sulphonates, which term is used to describe material made by reacting olefins, particularly (C₁₀-C₂₀) alpha-olefins, with SO₃ and then neutralising and hydrolysing the reaction product. The preferred anionic detergent compounds are sodium (C₁₀-C₁₅) alkylbenzene sulphonates, and sodium (C₁₆-C₁₈) alkyl ether sulphates.

Examples of suitable nonionic surface-active compounds which may be used, preferably together with the anionic surface-active compounds, include, in particular, the reaction products of alkylene oxides, usually ethylene oxide, with alkyl (C₆-C₂₂) phenols, generally 5-25 EO, i.e. 5-25 units of ethylene oxides per molecule; and the condensation products of aliphatic (C₈-C₁₈) primary or secondary linear or branched alcohols with ethylene oxide, generally 2-30 EO. Other so-called nonionic surface-actives include alkyl polyglycosides, sugar esters, long-chain tertiary amine oxides, long-chain tertiary phosphine oxides and dialkyl sulphoxides.

Amphoteric or zwitterionic surface-active compounds can also be used in the compositions of the invention but this is not normally desired owing to their relatively high cost. If any amphoteric or zwitterionic detergent compounds are used, it is generally in small amounts in compositions based on the much more commonly used synthetic anionic and nonionic actives.

The composition will preferably comprise from 1 to 15% wt of anionic surfactant and from 10 to 40% by weight of nonionic surfactant. In a further preferred embodiment, the detergent active system is free from C₁₆-C₁₂ fatty acid soaps.

The composition may also contain a detergency builder, for example in an amount of from about 5 to 80% by weight, preferably from about 10 to 60% by weight.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate; nitrilotriacetic acid and its water-soluble salts; the alkali metal salts of carboxymethyloxy succinic acid, ethylene diamine tetraacetic acid, oxydisuccinic acid, mellitic acid, benzene polycarboxylic acids, citric acid; and polyacetal carboxylates as disclosed in U.S. Pat. Nos. 4,144,226 and 4,146,495.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

In particular, the composition may contain any one of the organic and inorganic builder materials, though, for environmental reasons, phosphate builders are preferably omitted or only used in very small amounts. Typical builders usable in the present invention are, for example, sodium carbonate, calcite/carbonate, the sodium salt of nitrilotriacetic acid, sodium citrate, carboxymethyloxy malonate, carboxymethyloxy succinate and water-insoluble crystalline or amorphous aluminosilicate builder materials, each of which can be used as the main builder, either alone or in admixture with minor amounts of other builders or polymers as co-builder.

It is preferred that the composition contains not more than 5% by weight of a carbonate builder, expressed as sodium carbonate, more preferably not more than 2.5% by weight to substantially nil, if the composition pH lies in the lower alkaline region of up to 10.

Apart from the components already mentioned, the composition can contain any of the conventional additives in amounts of which such materials are normally employed in fabric washing detergent compositions. Examples of these additives include buffers such as carbonates, lather boosters, such as alkanolamides, particularly the monoethanol amides derived from palmkernel fatty acids and coconut fatty acids; lather depressants, such as alkyl phosphates and silicones; anti-redeposition agents, such as sodium carboxymethyl cellulose and alkyl or substituted alkyl cellulose ethers; stabilisers, such as phosphonic acid derivatives (i.e. Dequest® types); fabric softening agents; inorganic salts and alkaline buffering agents, such as sodium sulphate and sodium silicate; and, usually in very small amounts, fluorescent agents; perfumes; enzymes, such as proteases, cellulases, lipases, amylases and oxidases; germicides and colorants.

When using a hydrogen peroxide source, such as sodium perborate or sodium percarbonate, as the bleaching compound, it is preferred that the composition contains not more than 5% by weight of a carbonate buffer, expressed as sodium carbonate, more preferable not more than 2.5% by weight to substantially nil, if the composition pH lies in the lower alkaline region of up to 10.

Of the additives, transition metal sequestrants such as EDTA and the phosphonic acid derivatives, e.g. ethylene diamine tetra-(methylene phosphonate)-EDTMP- are of special importance, as not only do they improve the stability of the catalyst/H₂O₂ system and sensitive ingredients, such as enzymes, fluorescent agents, perfumes and the like, but also improve the bleach performance, especially at the higher pH region of above 10, particularly at pH 10.5 and above. Other suitable transition metal sequestrants are known and can be chosen by those skilled in the art, for example aminocarboxylates, aminophosphonates, and polyfunctionally substituted aromatic chelating agents, as disclosed further in WO-A-98/39406. If present, the sequestrants are generally present in amounts of 0.001 to 15%, more preferably 0.01 to 3.0%, by weight of the composition.

Throughout the description and claims generic groups have been used, for example alkyl, alkoxy, aryl. Unless otherwise specified the following are preferred group restrictions that may be applied to generic groups found within compounds disclosed herein:

alkyl: linear and branched C1-C8-alkyl,

alkenyl: C2-C6-alkenyl,

cycloalkyl: C3-C8-cycloalkyl,

alkoxy: C1-C6-alkoxy,

alkylene: selected from the group consisting of: methylene; 1,1-ethylene; 1,2-ethylene; 1,1-propylidene; 1,2-propylene; 1,3-propylene; 2,2-propylidene; butan-2-ol-1,4-diyl; propan-2-ol-1,3-diyl; 1,4-butylene; cyclohexane-1,1-diyl; cyclohexan-1,2-diyl; cyclohexan-1,3-diyl; cyclohexan-1,4-diyl; cyclopentane-1,1-diyl; cyclopentan-1,2-diyl; and cyclopentan-1,3-diyl,

aryl: selected from homoaromatic compounds having a molecular weight under 300,

arylene: selected from the group consisting of: 1,2-phenylene; 1,3-phenylene; 1,4-phenylene; 1,2-naphtalenylene; 1,3-naphtalenylene; 1,4-naphtalenylene; 2,3-naphtalenylene; 1-hydroxy-2,3-phenylene; 1-hydroxy-2,4-phenylene; 1-hydroxy-2,5-phenylene; and 1-hydroxy-2,6-phenylene,

heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl,

heteroarylene: selected from the group consisting of: pyridindiyl; quinolindiyl; pyrazodiyl; pyrazoldiyl; triazolediyl; pyrazindiyl; and imidazolediyl, wherein the heteroarylene acts as a bridge in the compound via any atom in the ring of the selected heteroarylene, more specifically preferred are: pyridin-2,3-diyl; pyridin-2,4-diyl; pyridin-2,5-diyl; pyridin-2,6-diyl; pyridin-3,4-diyl; pyridin-3,5-diyl; quinolin-2,3-diyl; quinolin-2,4-diyl; quinolin-2,8-diyl; isoquinolin-1,3-diyl; isoquinolin-1,4-diyl; pyrazol-1,3-diyl; pyrazol-3,5-diyl; triazole-3,5-diyl; triazole-1,3-diyl; pyrazin-2,5-diyl; and imidazole-2,4-diyl,

heterocycloalkyl: selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl,

heterocycloalkylene: selected from the group consisting of: piperidin-1,2-ylene; piperidin-2,6-ylene; piperidin-4,4-ylidene; 1,4-piperazin-1,4-ylene; 1,4-piperazin-2,3-ylene; 1,4-piperazin-2,5-ylene; 1,4-piperazin-2,6-ylene; 1,4-piperazin-1,2-ylene; 1,4-piperazin-1,3-ylene; 1,4-piperazin -1,4-ylene; tetrahydrothiophen-2,5-ylene; tetrahydrothiophen -3, 4-ylene; tetrahydrothiophen-2,3-ylene; tetrahydrofuran -2,5-ylene; tetrahydrofuran-3,4-ylene; tetrahydrofuran-2,3-ylene; pyrrolidin-2,5-ylene; pyrrolidin-3,4-ylene; pyrrolidin-2,3-ylene; pyrrolidin-1,2-ylene; pyrrolidin-1,3-ylene; pyrrolidin-2,2-ylidene; 1,4,7-triazacyclonon-1,4-ylene; 1,4,7-triazacyclonon-2,3-ylene; 1,4,7-triazacyclonon -2,9-ylene; 1,4,7-triazacyclonon-3,8-ylene; 1,4,7-triazacyclonon-2,2-ylidene; 1,4,8,11-tetraazacyclotetradec -1,4-ylene; 1,4,8,11-tetraazacyclotetradec-1,8-ylene; 1,4,8,11-tetraazacyclotetradec-2,3-ylene; 1,4,8,11-tetraazacyclotetradec-2,5-ylene; 1,4,8,11-tetraazacyclotetradec-1,2-ylene; 1,4,8,11-tetraazacyclotetradec-2,2-ylidene; 1,4,7,10-tetraazacyclododec-1,4-ylene; 1,4,7,10-tetraazacyclododec -1,7-ylene; 1,4,7,10-tetraazacyclododec-1,2-ylene; 1,4,7,10-tetraazacyclododec-2,3-ylene; 1,4,7,10-tetraazacyclododec -2,2-ylidene; 1,4,7,10,13-pentaazacyclopentadec-1,4-ylene; 1,4,7,10,13-pentaazacyclopentadec-1,7-ylene; 1,4,7,10,13-pentaazacyclopentadec-2,3-ylene; 1,4,7,10,13-pentaazacyclopentadec-1,2-ylene; 1,4,7,10,13-pentaazacyclopentadec-2,2-ylidene; 1,4-diaza-7-thia-cyclonon -1,4-ylene; 1,4-diaza-7-thia-cyclonon-1,2-ylene; 1,4-diaza-7-thia-cyclonon-2,3-ylene; 1,4-diaza-7-thia-cyclonon -6,8-ylene; 1,4-diaza-7-thia-cyclonon-2,2-ylidene; 1,4-diaza-7-oxa-cyclonon-1,4-ylene; 1,4-diaza-7-oxa-cyclonon -1,2-ylene; 1,4-diaza-7-oxa-cyclonon-2,3-ylene; 1,4-diaza-7-oxa-cyclonon-6,8-ylene; 1,4-diaza-7-oxa-cyclonon -2,2-ylidene; 1,4-dioxan-2,3-ylene; 1,4-dioxan-2,6-ylene; 1,4-dioxan-2,2-ylidene; tetrahydropyran-2,3-ylene; tetrahydropyran-2,6-ylene; tetrahydropyran-2,5-ylene; tetrahydropyran-2,2-ylidene; 1,4,7-trithia-cyclonon-2,3-ylene; 1,4,7-trithia-cyclonon-2,9-ylene; and 1,4,7-trithia-cyclonon -2,2-ylidene,

amine: the group —N (R)₂ wherein each R is independently selected from: hydrogen; C1-C6-alkyl; C1-C6-alkyl-C6H5; and phenyl, wherein when both R are C1-C6-alkyl both R together may form an -NC3 to an -NC5 heterocyclic ring with any remaining alkyl chain forming an alkyl substituent to the heterocyclic ring,

halogen: selected from the group consisting of: F; Cl; Br and I,

sulfonate: the group —S(O)₂OR, wherein R is selected from: hydrogen; C1-C6-alkyl; phenyl; C1-C6-alkyl-C6H5; Li; Na; K; Cs; Mg; and Ca, sulfate: the group -OS(O)₂OR, wherein R is selected from: hydrogen; C1-C6-alkyl; phenyl; C1-C6-alkyl -C6H5; Li; Na; K; Cs; Mg; and Ca,

sulfone: the group —S(O)₂R, wherein R is selected from: hydrogen; C1-C6-alkyl; phenyl; C1-C6-alkyl -C6H5 and amine (to give sulfonamide) selected from the group: —NR′2, wherein each R′ is independently selected from: hydrogen; C1-C6-alkyl; C1-C6-alkyl -C6H5; and phenyl, wherein when both R′ are C1-C6-alkyl both R′ together may form an -NC3 to an —NC5 heterocyclic ring with any remaining alkyl chain forming an alkyl substituent to the heterocyclic ring,

carboxylate derivative: the group —C(O)OR, wherein R is selected from: hydrogen; C1-C6-alkyl; phenyl; C1-C6-alkyl-C6H5; Li; Na; K; Cs; Mg; and Ca,

carbonyl derivative: the group —C(O)R, wherein R is selected from: hydrogen; C1-C6-alkyl; phenyl; C1-C6-alkyl-C6H5 and amine (to give amide) selected from the group: −NR′2, wherein each R′ is independently selected from: hydrogen; C1-C6-alkyl; C1-C6-alkyl -C6H5; and phenyl, wherein when both R′ are C1-C6-alkyl both R′ together may form an —NC3 to an —NC5 heterocyclic ring with any remaining alkyl chain forming an alkyl substituent to the heterocyclic ring,

phosphonate: the group —P(O) (OR)₂, wherein each R is independently selected from: hydrogen; C1-C6-alkyl; phenyl; C1-C6-alkyl -C6H5; Li; Na; K; Cs; Mg; and Ca, phosphate: the group —OP(O) (OR)₂, wherein each R is independently selected from: hydrogen; C1-C6-alkyl; phenyl; C1-C6-alkyl -C6H5; Li; Na; K; Cs; Mg; and Ca, phosphine: the group —P(R)₂, wherein each R is independently selected from: hydrogen; C1-C6-alkyl; phenyl; and C1-C6-alkyl -C6H5,

phosphine oxide: the group —P(O)R₂, wherein R is independently selected from: hydrogen; C1-C6-alkyl; phenyl; and C1-C6-alkyl -C6H5; and amine (to give phosphonamidate) selected from the group: —NR′2, wherein each R′ is independently selected from: hydrogen; C1-C6-alkyl; C1-C6-alkyl -C6H5; and phenyl, wherein when both R′ are C1-C6-alkyl both R′ together may form an —NC3 to an —NC5 heterocyclic ring with any remaining alkyl chain forming an alkyl substituent to the heterocyclic ring.

Unless otherwise specified the following are more preferred group restrictions that may be applied to groups found within compounds disclosed herein:

alkyl: linear and branched C1-C6-alkyl,

alkenyl: C3-C6-alkenyl,

cycloalkyl: C6-C8-cycloalkyl,

alkoxy: C1-C4-alkoxy, alkylene: selected from the group consisting of: methylene; 1,2-ethylene; 1,3-propylene; butan-2-ol-1,4-diyl; 1,4-butylene; cyclohexane-1,1-diyl; cyclohexan-1,2-diyl; cyclohexan-1,4-diyl; cyclopentane-1,1-diyl; and cyclopentan-1,2-diyl,

aryl: selected from group consisting of: phenyl; biphenyl; naphthalenyl; anthracenyl; and phenanthrenyl, arylene: selected from the group consisting of: 1,2-phenylene; 1,3-phenylene; 1,4-phenylene; 1,2-naphtalenylene; 1,4-naphtalenylene; 2,3-naphtalenylene and 1-hydroxy-2,6-phenylene,

heteroaryl: selected from the group consisting of: pyridinyl; pyrimidinyl; quinolinyl; pyrazolyl; triazolyl; isoquinolinyl; imidazolyl; and oxazolidinyl, wherein the heteroaryl may be connected to the compound via any atom in the ring of the selected heteroaryl,

heteroarylene: selected from the group consisting of: pyridin-2,3-diyl; pyridin-2,4-diyl; pyridin-2,6-diyl; pyridin-3,5-diyl; quinolin-2,3-diyl; quinolin-2,4-diyl; isoquinolin-1,3-diyl; isoquinolin-1,4-diyl; pyrazol-3,5-diyl; and imidazole-2,4-diyl,

heterocycloalkyl: selected from the group consisting of: pyrrolidinyl; morpholinyl; piperidinyl; piperidinyl; 1,4-piperazinyl; tetrahydrofuranyl; 1,4,7-triazacyclononanyl; 1,4,8,11-tetraazacyclotetradecanyl; 1,4,7,10,13-pentaazacyclopentadecanyl; 1,4,7,10-tetraazacyclododecanyl; and piperazinyl, wherein the heterocycloalkyl may be connected to the compound via any atom in the ring of the selected heterocycloalkyl,

heterocycloalkylene: selected from the group consisting of: piperidin-2,6-ylene; piperidin-4,4-ylidene; 1,4-piperazin-1,4-ylene; 1,4-piperazin-2,3-ylene; 1,4-piperazin -2,6-ylene; tetrahydrothiophen-2,5-ylene; tetrahydrothiophen -3,4-ylene; tetrahydrofuran-2,5-ylene; tetrahydrofuran-3,4-ylene; pyrrolidin-2,5-ylene; pyrrolidin-2,2-ylidene; 1,4,7-triazacyclonon-1,4-ylene; 1,4,7-triazacyclonon-2,3-ylene; 1,4,7-triazacyclonon-2,2-ylidene; 1,4,8,11-tetraazacyclotetradec-1,4-ylene; 1,4,8,11-tetraazacyclotetradec-1,8-ylene; 1,4,8,11-tetraazacyclotetradec-2,3-ylene; 1,4,8,11-tetraazacyclotetradec-2,2-ylidene; 1,4,7,10-tetraazacyclododec-1,4-ylene; 1,4,7,10-tetraazacyclododec-1,7-ylene; 1,4,7,10-tetraazacyclododec-2,3-ylene; 1,4,7,10-tetraazacyclododec-2,2-ylidene; 1,4,7,10,13-pentaazacyclopentadec-1,4-ylene; 1,4,7,10,13-pentaazacyclopentadec-1,7-ylene; 1,4-diaza-7-thia-cyclonon -1,4-ylene; 1,4-diaza-7-thia-cyclonon-2,3-ylene; 1,4-diaza-7-thia-cyclonon-2,2-ylidene; 1,4-diaza-7-oxa-cyclonon-1,4-ylene; 1,4-diaza-7-oxa-cyclonon-2,3-ylene;1,4-diaza-7-oxa-cyclonon -2,2-ylidene; 1,4-dioxan-2,6-ylene; 1,4-dioxan-2,2-ylidene; tetrahydropyran-2,6-ylene; tetrahydropyran-2,5-ylene; and tetrahydropyran-2,2-ylidene,

amine: the group —N (R)₂, wherein each R is independently selected from: hydrogen; C1-C6-alkyl; and benzyl, halogen: selected from the group consisting of: F and Cl,

sulfonate: the group —S(O)₂OR, wherein R is selected from: hydrogen; C1-C6-alkyl; Na; K; Mg; and Ca,

sulfate: the group —OS(O)₂OR, wherein R is selected from: hydrogen; C1-C6-alkyl; Na; K; Mg; and Ca,

sulfone: the group —S(O)₂R, wherein R is selected from: hydrogen; C1-C6-alkyl; benzyl and amine selected from the group: —NR′2, wherein each R′ is independently selected from: hydrogen; C1-C6-alkyl; and benzyl,

carboxylate derivative: the group —C(O)OR, wherein R is selected from hydrogen; Na; K; Mg; Ca; C1-C6-alkyl; and benzyl,

carbonyl derivative: the group: —C(O)R, wherein R is selected from: hydrogen; C1-C6-alkyl; benzyl and amine selected from the group: —NR′2, wherein each R′ is independently selected from: hydrogen; C1-C6-alkyl; and benzyl,

phosphonate: the group —P(O) (OR)₂, wherein each R is independently selected from: hydrogen; C1-C6-alkyl; benzyl; Na; K; Mg; and Ca,

phosphate: the group —OP(O) (OR)₂, wherein each R is independently selected from: hydrogen; C1-C6-alkyl; benzyl; Na; K; Mg; and Ca,

phosphine: the group —P(R)₂, wherein each R is independently selected from: hydrogen; C1-C6-alkyl; and benzyl,

phosphine oxide: the group —P(O)R₂, wherein R is independently selected from: hydrogen; C1-C6-alkyl; benzyl and amine selected from the group: —NR′2, wherein each R′ is independently selected from: hydrogen; C1-C6-alkyl; and benzyl.

The present invention will now be further illustrated by the following non-limiting examples:

### EXAMPLES

Three formulations (Products “A”, “B” and “C”) were tested, having the following compositions:

| | Product “A” | Product “B” | Product “C” |
|---|---|---|---|
| Detergent | 55 g | 55 g | 55 g |
| Base (*) | | | |
| Antifoam | 2.7 g | 2.7 g | 2.7 g |
| Granule | | | |
| Na | 0.9 g | 0.9 g | 0.9 g |
| Bicarbonate | | | |
| Nabion 15 (**) | 5.0 g | 5.0 g | 5.0 g |
| Dequest 2047 | 0.9 g | 0.9 g | 0.9 g |
| Savinase | 0.6 g | 0.6 g | 0.6 g |
| 12.0T | | | |
| Na | 17.1 g | 17.1 g | 17.1 g |
| Percarbonate | | | |
| TAED granule | — | 2.3 g | 4.5 g |
| (83% active) | | | |
| FeMeN4Py | 0.05 g | 0.05 g | — |

(*) The composition of the detergent base in each case was as follows:

| Compound | Wt % |
|---|---|
| Na-LAS | 12.98 |
| Nonionic 7EO, branched | 7.45 |
| Nonionic 3EO, branched | 4.0 |
| Zeolite A24 (anhydrous) | 48.53 |
| Light soda ash | 9.53 |
| Sodium carbonate, dense | 5.72 |
| coarse | |
| Soap | 1.83 |
| SCMC tel qel (69%) (***) | 0.88 |
| Water/salts | 7.83 |

(**) sodium silicate/sodium carbonate co-granulate (30% sodium silicate)
(***) sodium carboxymethylcellulose, 69% active

### Wash Conditions

A single replicate of 40 wash cycles using wash loads containing the commercial articles and enough desized cotton ballast to increase the weight of the load to 2.5 kg, and four washing machines.

| | |
|---|---|
| Machine | Miele W756 |
| Wash cycle | as recommended |
| Water hardness | 24 degrees FH |
| Intake volume | 14.5 litres |
| Intake temp | ambient |
| Load | monitors (+ballast to make 2.5 kg) |
| Dispensing | powder delivered via a scuttle |

catalyst by addition to the water intake through the dispenser drawer after dispensing in 50 ml water.

The articles were split into two loads (40° C. and 50° C.) according to the retailer's recommended wash conditions for each garment. Rotation across machines was on a daily basis, with one complete day's washing per machine per test product followed by rotation.

On completion of each day's washes, the machines were taken through a 60° C. wash with the control product, dosed at 50 g, without any load, and the dispenser was cleaned out. Ballast loads were only used with the same test product and tumble dried for overnight storage.

### Example 1 (Bleach Performance)

The bleach monitor BC-1 (tea stain) was added to random washes to check bleach performance. The bleach performance (quoted as ΔR460), averaged from 10 washes, is shown in Table 1 below:

TABLE 1

Bleach Performance
(mean ΔR460 on BC-1)

| Product | 40° C. | 50° C. |
|---|---|---|
| A | 13.41 | 22.48 |
| B | 15.52 | 23.94 |
| C | 12.72 | 19.91 |

From the results in Table 1, it may be seen that the current TAED/percarbonate bleach system (C) gives inferior stain removal compared to either the catalyst/percarbonate (A) or catalyst/TAED/percarbonate (B) products. Bleach system (B) according to the invention gave the best bleaching performance.

### Example 2 (Dye Fading)

The following tables show the levels of dye fading observed in the above multi-wash experiments for a series of article purchased from clothing retailers in the UK. A single dyed test cloth (8% Remazol Black B on woven cotton) was also included in both 40 and 50° C. studies.

In each case, dye fading is expressed in terms of color change from the original unwashed article (ΔE) following 40 wash cycles. A larger value of ΔE indicates a larger color change from the original and hence a more faded dye.

Tables 2 and 3 below show the dye fading observed after 40 wash cycles for each product (A,B,C):

TABLE 2

| | 50° C. washes | | | | | |
|---|---|---|---|---|---|---|
| | | Ladies | Girls | Crop top | | |
| | | low legs | pedal | 59% | | |
| | | 67% | pushers | cotton/ | | |
| | Mens | cotton/ | 98% | 30% | | |
| | pyjama | 29% | cotton/ | Tactel/ | Mens | Ramazol |
| | top | Tactel/ | 2% | 11% | vest | Black |
| | 100% | 4% | elastane | elastane | T-shirt | Test |
| | cotton | elastane | Lycra | Lycra | 100% | Cloth |
| | navy | Lycra | Navy | navy | cotton | P06CR |
| Product | blue | black | blue | blue | green | black |
| A | 6.19 | 6.82 | 12.31 | 9.21 | 2.22 | 6.91 |
| B | 15.87 | 11.71 | 12.66 | 8.25 | 2.80 | 7.38 |
| C | 21.82 | 12.89 | 19.33 | 12.19 | 6.08 | 13.03 |

TABLE 3

| | 40° C. washes | | | | |
|---|---|---|---|---|---|
| | Boys | | | | |
| | T-shirt | | Boys | Boys | Ramazol |
| | 100% | Ladies | T-shirt | shorts | Black |
| | cotton | Knickers | 100% | 100% | Test |
| | navy | 100% | cotton | cotton | Cloth |
| | blue/ | cotton | navy | Navy | P06CR |
| Product | print | Black | blue/red | blue | black |
| A | 5.53 | 3.22 | 4.8 | 3.25 | 4.85 |
| B | 11.62 | 11.16 | 10.87 | 9.65 | 8.13 |
| C | 12.77 | 13.95 | 12.61 | 10.19 | 7.0 |

From the results in Tables 2 and 3, it may be seen that the current TAED/percarbonate bleach system (C) gives more dye fading than either the catalyst/percarbonate (A) or catalyst/TAED/percarbonate (B) products.

### Example 3

The results of bleaching of BC-1 and dye fading of Direct Green dye 006 CS on cotton cloth in 40° C. stirred beaker washes (5 g/l of a European zeolite formulation, bleach as indicated, no enzymes, 40° C., 60 minutes, Liquor/Cloth ratio (wt/wt) L/C˜50) are shown in Table 4 below:

TABLE 4

| | | ΔR_{460*} | ΔE- |
|---|---|---|---|
| Bleach system | | (BC-1) | O06CS |
| 8.2 mM | — | 10.7 | 1.7 |
| percarbonate | | | |
| 8.2 mM | +1 mM TAED | 14.2 | 7.2 |
| percarbonate | | | |
| 8.2 mM | +5 ΔM catalyst 1 | 18.9 | 4.7 |
| percarbonate | | | |

### Example 4

The results of 24 wash dye fading of 2 commercial tea towels and single wash BC-1 bleach in 90° C. machine washes (5 g/l of a European zeolite formulation with bleach as indicated, L/C˜4) are shown in Table 5 below:

TABLE 5

| | | | | Black/ | Green/ |
|---|---|---|---|---|---|
| | | | | white | white |
| | | | | tea | tea |
| Bleach system | | | BC-1 | towel | towel |
| Percarbonate | TAED | Catalyst 1 | bleach | fading | fading |
| (%) | (%) | (%) | ΔR460* | ΔE | ΔE |
| 19.0 | — | — | 28.5 | 3.03 | 6.67 |
| 19.0 | 5.5 | | 30.9 | 16.30 | 11.53 |
| 19.0 | | 0.05 | 34.1 | 9.04 | 9.40 |
| 19.0 | 5.5 | 0.05 | 34.1 | 17.21 | 16.97 |
| 19.0 | | 0.01 | 31.5 | 2.75 | — |
| 19.0 | 2.0 | 0.01 | 32.7 | 10.45 | 5.02 |
| 19.0 | | 0.02 | 32.1 | 5.07 | 6.74 |
| 19.0 | 2.0 | 0.02 | 33.1 | 7.37 | 10.09 |

The examples above demonstrate that the use of the bleach catalyst FeMeN4Py in conjunction with sodium percarbonate as a source of hydrogen peroxide gives much reduced dye fading compared to a conventional precursor/peroxide system (TAED/percarbonate) whilst delivering equivalent or improved stain bleaching. The FeMeN4Py catalyst used with the peroxide source and low levels of TAED, in accordance with the invention, similarly gives reduced dye fading compared to the conventional TAED/percarbonate system, whilst delivering improved stain bleaching.

### Example 5

The following compounds were prepared and with regard to dye-fading activity.

(i) Preparation of MeN4Py ligand N,N-bis(pyridin-2-yl-methyl)-1,1-bis(pyridin-2-yl)-1aminoethane, MeN4Py, was prepared according to the procedure found in EP 0 909 809 A.

(ii) Synthesis of the complex FeMeN4PyCl₂ (complex 1) MeN4Py ligand (33.7 g; 88.5 mmoles) was dissolved in 500 ml dry methanol. Small portions of FeCl₂. 4H₂O (0.95eq; 16.7 g; 84.0 mmoles) were added, yielding a clear red solution. After addition, the solution was stirred for 30 minutes at room temperature, after which the methanol was removed (rotary-evaporator). The dry solid was ground and 150 ml of ethylacetate was added and the mixture was stirred until a fine red powder was obtained. This powder was washed twice with ethyl acetate, dried in the air and further dried under vacuum (40 oC). El. Anal. Calc. for [Fe(MeN4py)Cl]Cl.2H₂O: C 53.03; H 5.16; N 12.89; Cl 13.07; Fe 10.01%. Found C 52.29/52.03; H 5.05/5.03; N 12.55/12.61; Cl: 12.73/12.69; Fe: 10.06/10.01%.

### Complex 2: [(N4Py)FeCl]Cl

Complex 2 was synthesised according to the procedure as described for the analogous MeN4py complex using now N4py (N,N-bis(pyridin-2-yl-methyl)-1,1-bis(pyridin-2-yl)-1-aminomethane) as ligand (see above). The N4py ligand has been prepared as described in Wo-A-9534628.

### Complex 3 [(N3pyMe)Fe(CH₃CN) 2] (C10₄)₂

This compound has been synthesised as described elsewhere (W00060044). (N3pyMe=1,1-bis(pyridin-2-yl)-N-methyl-N-(pyridin -2-ylmethyl)methylamine

### Complex 4: [Fe(L1)]Cl]PF₆

(L1=N-Methyl-N,N′, N′-tris(3-methylpyridin -2ylmethyl)ethylenediamine).This compound has been synthesised as described elsewhere (W00027976).

### Complex 5: [Fe(N-Methyl-N,N′, N′-tris(pyridin-2ylmethyl)ethylenediamine]Cl]PF₆

N-methyl-,N,N′N′-tris(pyridin-2ylmethyl)ethane-diamine (trispicen-NMe). This ligand was prepared according to a modified procedure described by Bernal et al (J. Chem. Soc., Dalton Trans, 22, 3667 (1995)).

First N,N′-bis(pyridin-2ylmethyl)-ethanediamine (bispicen) was synthesised by the following procedure. Ethylenediamine (26 ml, 0.38 mol) was dissolved in 200 ml dry methanol. To this mixture 74 ml (0.76 mol) pyridincarboxaldehyde was added. The mixture was refluxed for 2 h, after which the mixture was left to cool to RT and in small portions 40 g of NaBH₄ was added. The mixture was subsequently stirred for 16 h at RT. The methanol was evaporated and 500 ml of water was added. The aqueous mixture was extracted by three portions of dichloromethane (100 ml) and the dichloromethane solution was dried over sodium sulfate, filtered off and the solvent was removed. The dark oil containing N,N′-bis(pyridin-2ylmethyl)-ethanediamine (73.7 g; 81%) was analysed by NMR and used without further purification. ¹H-nmr (CDCl₃): δ5 2.20 (br, NH); 2.78 (s, 4H); 3.85 (s, 4H); 7.00-7.40 (m, 4H); 7.58 (m, 2H) ; 8.45 (m, 2H).

In the second step the aminal of bispicen with 2-pyridincarboxaldehyde was synthesised. 73,7 g of the unpurified bispicen material (see above) was under argon dissolved in 750 ml of dry diethyether (distilled over P₂O₅. To this solution 32.8 of 2-pyridincarboxaldehyde was added, the reaction mixture was stirred and cooled in an ice/water bath. After 20 min a white precipitate was formed that was filtered off (P4-glass filter) and dried with dry ether. The yield was 66.6 g (66%) and was used without further purification. ¹H-nmr (CDCl₃): 2.75 (m, 2H); 3.13 (m, 2H); 3.65 (d, 2H); 4.93 (d, 2H); 4.23 (s, 1H); 7.00-7.90 (m, 9H); 8.43 (m, 3H).

In the third step the desired ligand was obtained (N,N,N′ tris(pyridin-2ylmethyl)ethane-diamine-trispicen-NH). The aminal (45.0 g; 0.135 mol), obtained as described as above, was dissolved in 1.2 1 of dry methanol (distilled over Mg), and to this mixture 8.61 g (0.137 mol) of NaBCNH₃ was added in small portions. Subsequently 21 ml of trifluoroacetic acid was added dropwise in the solution. The mixture was stirred for 16 h at RT and subsequently 1.05 L of 5N NaOH was added and the mixture was stirred for 6 h. Extraction with dichloromethane yielded after drying, filtration and removal of the solvent a yellow oil as product (42.7 g , 0.128 mol; 95%. ¹H-nmr (CDCl₃): δ5 2.15 (br, NH); 2.75 (s, 4H); 3.80 (s, 4H); 3.82(s, 2H); 7.0-7.8 (m, 3H); 7.45-7.70 (m, 6H); 8.40-8.60 (m, 3H). ¹³C-nmr (CDCl₃): δ553.9 (t); 54.7 (t); 60.4 (t); 121.7 (d); 121.9 (d); 122.1 (d); 123.0 (d); 136.3 (d); 136.4 (d); 148.9 (d); 149.1 (d); 159.3 (s); 159.6 (s).

The desired ligand was obtained by the following procedure: trispicen-NH (10 g, 30 mmol) was dissolved in 25 ml formic acid and 10 ml water. To this mixture 36% formaldehyde solution was added (16 ml, 90 mmol) and the mixture was warmed up till 90° C. for 3 h. Formic acid was evaporated and the 2.5 N NaOH solution was added until the pH was higher than 9. Extraction by dichloromethane and drying over sodium sulfate, filtration of the solution and subsequently drying yielded a dark-colored oil (8.85 g). The oil was purified over a alumina column (elutant: ethyl acetate/ hexane/triethylamine 9:10:1). Yield 7,05 g pale yellow oil (20,3mmoles; 68%). ¹H-nmr (CDCl₃): δ6 2.18 (s, 3H); 2.65 (m, 2H); 2.75 (m, 2H); 3.60 (s; 2H); 3.83 (s; 4H); 7.10 (m, 3H); 7.3-7.6 (m, 6H); 8.5 (d, 3H).

The iron complex 5 has been synthesised as follows: TrispicenNMe (6,0 g; 17,3 mmoles) was dissolved in 15 ml methanol/water 1/1 v/v) and was heated till 50° C. FeCl₂.4H₂O 3,43 g; 17, 0 mmoles), dissolved in 20 ml water/methanol 1/1), was added. The dark solution was stirred for 20 min at 50° C. Subsequently 3.17 g (17 mmol) of KPF₆ dissolved in 10 ml water, was added and the solution was stirred for 15 h to yield a yellow precipitation. The solid was filtered off, wasged with methanol/water 1/1, v/v) and ethyl acetate. Drying yielded 8.25 g of a pale-yellow powder.

### Complex 6: [(tpen)Fe] (ClO₄)₂

This compound was prepared according to the procedure found in H. Toftlund et al., J. Am. Chem. Soc., 112, 6814 (1990). (tpen=tetrakis(pyridin-2-ylmethyl)ethylenediamine).

### Complex 7: [Fe(1-[di(2-pyridinyl)methyl]-4,7-dimethyl-1,4,7-triazacyclonane) (CH₃CN)] (C10₄)₂

This compound was made as described elsewhere (WO006004).

### Experimental

Experiments were conducted to investigate bleaching performance of the bleach catalysts and one free ligand in a formulation on tomato stain, and dye fading properties on 0.06. CS (Direct Green monitor) in the presence of the bleach catalysts or ligand.

Formulation A:

| | |
|---|---|
| Na-LAS | 8.7% |
| Nonionic 7EO, branched | 4.6% |
| Nonionic 3EO, branched | 2.4% |
| Soap | 1.1% |
| Zeolite A24 (anhydrous) | 29.6% |
| Na-citrate 2 aq | 3.52 |
| SCMC-sodium carboxymethylcellulose (68%) | 0.5% |
| Moistures, salts, NDOM | 4.8% |
| PVP: K-15 solution, ISP technologies, Inc. | 0.6% |

Stain: tomato-soya sauce oil stain

Dye: 0.06. CS (Direct Green monitor)

A stock solution of 3 g/l of formulation A in water (16 ⁰FH) was prepared. The containing 10 μM of the metal catalyst or 20 μM of the ligand. Bottles tests were done (25 mL solution) containing 10 μM of the metal catalyst or 20 μM of the ligand, each bottle containing a 0.06. CS cloth (Direct Green monitor —4×4 cm). In a seperate series of tests, a tomato stained cloth (4×4 cm) was added in the bottle, with no dyed cloths present. In comparative experiments no catalysts or ligand was added (blank) or the formulation A was used with 0.57 g TAED added, 0.03 g Dequest 2047 and 0.165 g percarbonate (PC) (current bleach product).

The cloths were washed for 30 min at 40° C. After the wash, the cloths were rinsed with water and subsequently dried, and the change in reflectance at 460 nm was measured immediately after drying on a Minolta CM-3700d spectrophotometer including a UV Vis filter before and after treatment (t=0 in the table). The cloths were subsequently stored for 24 h under ambient conditions and measured again (t=1 in the table).

The difference in ΔR between both reflectance values gives a measure of the bleaching performance of the system on the stain, i.e. a higher ΔR value corresponds to an improved bleaching performance. On the other hand, a higher ΔR value for the dyed cloth indicates more dye fading which is undesired.

The results for bleaching performance on tomato stains and dye fading on 0.06 CS are shown in the table below.

TABLE 6

| | | | |
|---|---|---|---|
| | | ΔR (Tomato | |
| | | stain) | |
| | Compound | t = 0 | ΔR |
| Experiment | added | t = 1 | 0.06CS |

| | | | | |
|---|---|---|---|---|
| 1 | — | 14 | 15 | 3 |
| 2 | TAED/PC | | 16 | 11 |
| 3 | 10 μM1 | 31 | 40 | 4 |
| 4 | 10 μM2 | 19 | 21 | 4 |
| 5 | 10 μM3 | 17 | 18 | 3 |
| 6 | 10 μM4 | 31 | 41 | 3 |
| 7 | 10 μM5 | 16 | 19 | 3 |
| 8 | 10 μM6 | 15 | 17 | 4 |
| 9 | 10 μM7 | 27 | 35 | 4 |
| 10 | 20 μM L1 | 19 | 22 | 4 |

The results in Table 6 indicate that:

The compounds give significant bleaching of tomato stain in the presence of hydrogen peroxide.

No dye fading effect on the bleach sensitive monitor 0.06 CS was observed in the bleach solution containing hydrogen peroxide and the metal compounds or ligand, even though the current bleach-containing product gives a significant dye fading.

1. A bleaching composition for laundry fabrics, comprising:
hydrogen peroxide or a source of hydrogen peroxide;
a bleach catalyst comprising a ligand which forms a complex with a transition metal, the complex catalysing bleaching of stains in the presence of peroxygen bleach or a peroxy-based or -generating bleach system; and
less than 4.0% by weight of a peroxyacid bleach precursor.

2. A bleaching composition according to claim 1, wherein the amount of peracid bleach precursor is less than 2.0%

3. A bleaching composition according to claim 1, wherein the molar ratio of peracid bleach precursor to catalyst is from 1:1 to 1000: 1, preferably from 10:1 to 500:1.

4. A bleaching composition according to claim 1, wherein the peroxyacid bleach precursor is tetraacetyl ethylenediamine (TAED).

5. A bleaching composition according to claim 4, wherein the amount of TAED is from 0.001 to less than 4% by weight, preferably from 0.01 to less than 2% by weight, more preferably from 0.1 to 1% by weight, of the composition.

6. A bleaching composition according to claim 1, wherein the source of hydrogen peroxide is sodium percarbonate.

7. A bleaching composition according to claim 6, wherein the sodium percarbonate is present in an amount of from 1 to 40% by weight, preferably from 1 to 20% by weight, more preferably from 1 to 15% by weight, and most preferably from 1 to 10% by weight, of the composition.

8. A bleaching composition according to claim 7, wherein the weight ratio of percarbonate to TAED is from 20:1 to 2:1, preferably from 10:1 to 4:1, more preferably from 8:1 to 4:1.

9. A bleaching composition according to claim 8, wherein the weight ratio of TAED to catalyst is from 100:1 to 2:1, preferably from 10: 1 to 4: 1, more preferably from 8:1 to 4:1.

10. A bleaching composition according to claim 1 in a wash liquor, wherein the amount of catalyst is from 0.05 μM to 50 mM, preferably from 1 μM to 100 μM.

11. A bleaching composition according claim 1 in a wash liquor, wherein the amount of peracid bleach precursor is from 0.5 μM to 100 μM, preferably from 1 μM to 10 μM.

12. A bleaching composition according to claim 1, wherein the catalyst comprises a pentadentate ligand of the general formula (IVE): 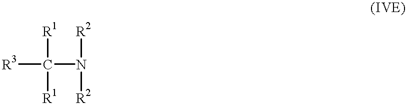
wherein
each R¹, R² independently represents —R⁴—R⁵,
R³ represents hydrogen, optionally substituted alkyl, aryl or arylalkyl, or —R⁴—R⁵,
each R⁴ independently represents a single bond or optionally substituted alkylene, alkenylene, oxyalkylene, aminoalkylene, alkylene ether, carboxylic ester or carboxylic amide, and
each R⁵ independently represents an optionally N-substituted aminoalkyl group or an optionally substituted heteroaryl group selected from pyridinyl, pyrazinyl, pyrazolyl, pyrrolyl, imidazolyl, benzimidazolyl, pyrimidinyl, triazolyl and thiazolyl.

13. A bleaching composition according to claim 1, wherein the ligand is N,N-bis(pyridin-2-yl-methyl)-1,1-bis(pyridin-2-yl)-1-aminoethane.

14. A bleaching composition according to claim 1, wherein the ligand forms a complex of the general formula:
[MₐLₖXₙ]Yₘ
in which:
M represents a metal selected from Mn(II)-(III)-(IV)-(V), Cu(I)-(II)-(III), Fe (II)-(III)-(IV)-(V), Co(I)-(II)-(III), Ti(II)-(III)-(IV), V(II)-(III)-(IV)-(V), Mo(II)-(III)-(IV)-(V)-(VI) and W(IV)-(V)-(VI), preferably from Fe (II)-(III)-(IV)-(V);
L represents the ligand, or its protonated or deprotonated analogue;
X represents a coordinating species selected from any mono, bi or tri charged anions and any neutral molecules able to coordinate the metal in a mono, bi or tridentate manner;
Y represents any non-coordinated counter ion;
a represents an integer from 1 to 10;
k represents an integer from 1 to 10;
n represents zero or an integer from 1 to 10;
m represents zero or an integer from 1 to 20.

15. A bleaching composition according to claim 1, wherein the composition provides a pH value in the range from pH 6 to 11, preferably in the range from pH 8 to 10, in aqueous medium.

16. A bleaching composition according to claim 1, wherein the composition further comprises a surfactant.

17. A bleaching composition according to claim 16, wherein the composition further comprises a builder.

18. A bleaching composition according to claim 1, wherein the catalyst comprises a preformed complex of the ligand and a transition metal.

19. A bleaching composition according to claim 1, wherein the composition comprises free ligand that complexes with a transition metal present in the water.

20. A bleaching composition according to claim 1, wherein the composition comprises a free ligand that complexes with a transition metal present in the substrate.

21. A bleaching composition according to claim 1, wherein the composition comprises free ligand or a transition metal-substitutable metal-ligand complex, and a source of transition metal.

22. A method of bleaching stains on laundry fabrics comprising contacting the stained fabric, in a wash liquor, with a bleaching composition as defined in claims 1.
